(19) United States
(12) Patent Application Publication
(10) Pub. No.: US 2022/0208016 A1
(43) Pub. Date: Jun. 30, 2022

(54) LIVE LECTURE AUGMENTATION WITH AN AUGMENTED REALITY OVERLAY

(71) Applicant: Chegg, Inc., Santa Clara, CA (US)

(72) Inventor: Vincent LE CHEVALIER, Waikoloa, HI (US)

(21) Appl. No.: 17/558,831

(22) Filed: Dec. 22, 2021

Related U.S. Application Data
(60) Provisional application No. 63/130,580, filed on Dec. 24, 2020.

(51) Int. Cl. G09B 5/14; G06F 3/01; G06T 19/00; H04L 12/18

(52) U.S. Cl. CPC G09B 5/14; H04L 12/1831; G06T 19/006; G06F 3/017

(57) ABSTRACT

Systems and methods are described that are directed to an augmented reality (AR) overlay that augments traditional lecture content items with corresponding augmented content, thereby facilitating a user's learning process. For example, a live multimedia lecture is captured and recognized by a client device, and corresponding augmented content are retrieved and displayed in relation to a video recording of the video lecture content as an augmented reality AR overlay. A plurality of user customizable hands gesture commands are also implemented, which enable a user to interact with the video lecture content and any supplement content by entering a hand gesture. A user customizable hands gesture command correlates a pre-defined and recognized hand gesture to the automatic execution of a particular series of actions performed by the command, such as automatically recording a snippet of the video lecture content, or automatically capturing a user-defined note.

### RELATED APPLICATION

This application claims the benefit of U.S. Provisional Application No. 63/130,580, filed on Dec. 24, 2020, the contents of which are incorporated herein by reference in their entirety.

### TECHNICAL FIELD

This disclosure relates to automatically providing learning activities to users watching a live multimedia lecture as an augmented reality (AR) overlay.

### BACKGROUND

Watching a live lecture online, such as a course lecture, can be difficult. If a student loses attention for a few moments, or otherwise does not understand the content of the lecture even for a few minutes, the student may miss out on important concepts being presented by the professor or lecturer.

Currently, when live lectures are presented through a provider such as Zoom or Webex, students are able to raise their hand and ask the professor a question. In addition, the students are able to chat with each other, the professor, or with the entire class. However, even if the professor records the lecture and the students are able to save the chats, the chats are not synchronized with the recorded lecture. Accordingly, there is a need for an online learning platform that provides augmented information to the lecture that makes the material and concepts presented in the lecture easier to understand for the student.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an online education system 100 in accordance with some embodiments.

FIG. 2 is a flowchart illustrating a method 200 of processing content in content repository 120 in accordance with some embodiments.

FIG. 3 depicts a block diagram for an example data structure for the content repository 120 for storing educational content and learning activity content in accordance with some embodiments.

FIG. 4 depicts a block diagram for an example data structure for storing user information in accordance with some embodiments.

FIG. 5 is a flowchart illustrating a method 500 of determining a user learning profile 430 in accordance with some embodiments.

FIG. 6 is a flowchart illustrating a method 600 of generating a set of supplemental content to be presented as an AR overlay for a user in accordance with some embodiments.

FIG. 7A illustrates an interface 700 for presenting the supplemental content to a user in accordance with some embodiments.

FIG. 7B illustrates another example of an interface 700 for presenting the supplemental content to a user in accordance with some embodiments.

FIG. 7C illustrates another example of an interface 700 for presenting the supplemental content to a user in accordance with some embodiments.

FIG. 7D illustrates another example of an interface 700 for presenting multiple snippets and the supplemental content to a user in accordance with some embodiments.

FIG. 8 illustrates an interface 800 for presenting the supplemental content to a user in accordance with some embodiments.

FIG. 9 illustrates an interface 900 for interacting with the supplemental content using hands gesture commands from a user in accordance with some embodiments.

FIG. 10 is a flowchart illustrating a method 1000 of generating a hands gesture command for automatically interacting with supplemental content in accordance with some embodiments.

FIG. 11 is a block diagram of a server system 1100 in accordance with some embodiments.

The figures are not exhaustive and do not limit the present disclosure to the precise form disclosed.

### DETAILED DESCRIPTION

Reference will now be made in detail to various embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. According to the present disclosure, an augmented reality (AR) overlay augments traditional lecture content items (hereinafter referred to as “video lecture content”) with corresponding augmented content, thereby facilitating a user's learning process. Accordingly, the present disclosure provides an augmented reality application, where a live multimedia lecture is captured and recognized by a client device, and corresponding augmented content are retrieved and displayed in relation to a video recording of the video lecture content as an augmented reality (AR) overlay.

The overlay can be presented in any of a number of ways. For example, the overlay can be provided in a fixed space on a screen of the user's device, such as mobile device. In other examples, the overlay may be presented in relation to the recognized content. For example, as a user scrolls through a recording of the video lecture content (whether it be snippets of the video lecture content or the entirety of the video lecture), augmented content retrieved for particular content (e.g., augmented content associated with the lecture content occurring at runtime 10 minutes) may appear as part of the AR overly. As the recording of the lecture continues to play, and the particular content item (e.g., occurring at runtime 10 minutes) is no longer being rendered, the retrieved augmented content may disappear. Augmented content retrieved for particular content (e.g., augmented content associated with the lecture content occurring at runtime 15 minutes) may now appear as part of the AR overlay. As the recording of the lecture continues to play further, and the particular content item (e.g., occurring at runtime 15 minutes) is no longer being rendered, the retrieved augmented content may be replaced in the AR overlay with more relevant supplemental content.

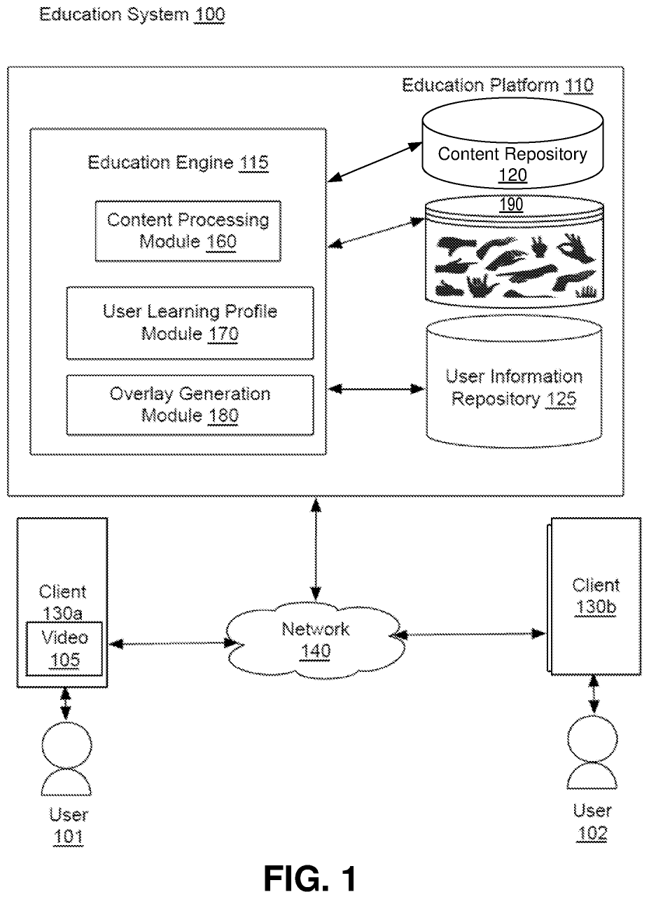

FIG. 1 illustrates an online education system 100 in accordance with some embodiments. Education system 100 includes an education platform 110 that provides personalized augmented content to a plurality of users, including users 101 and 102. In some implementations, thousands, even millions of users use education platform 110 to access educational content.

The education platform 110 is communicatively coupled to client devices 130 and 132 via a network 140. A client 130 accesses digital content from education platform 110 through network 140 and presents video lecture content to a user 101. Example client devices 130 include a desktop, a laptop, a tablet, a mobile device, smartphone, a smart television, a wearable device, a virtual reality device, etc. Client 130 may include software, such as a web browser or other application for rendering the video lecture content. FIG. 1 illustrates only two users 101 and 102 with respective client devices 130a and 130b. But there could be thousands, even millions of users, each with one or more associated client devices. A particular user 101 may access education platform 110 using one or more client devices 130 and may even start a session with education platform 110 with a first client device (e.g., laptop) and continue the session with a second client device (e.g., mobile device).

User 101 uses computing device 130 to capture a recording of a video lecture 105. A live lecture corresponding to the video lecture 105 may be happening in a physical space, such as, classroom environment, a professor's home office, etc. User 101 may be physically present in the physical space and use their client device 130 to capture a recording of the live lecture, or the user 101 may not be physically present and in such a case, a video lecture 105 is delivered to clients 130, such as network 150. As an example, users 101 and 102 may be students in a course, such as Geometry, and the live video lecture 105 may correspond to a lecture by a professor on the Pythagoras theorem. The user 101 uses a camera included in client 130 (or otherwise physically or communicatively coupled to client 130, such as, via LAN, Bluetooth, etc.), to make a recording of the video lecture 105. The education platform 110 may identify associated content corresponding to the captured recording, and provide supplemental content for display on the client device 130. The client device 130 may display the associated content as an augmented reality overlay is relation to the captured recording.

The client computing devices 130 may include any of a variety of types of augmented reality enabled devices that is capable of capturing audio/video recordings, communicating over a network, and has a display. By way of example and not limitation, such devices may include smart phones, cameras with wireless network access, laptops, smartwatches, tablets, head-mounted displays, gaming systems, AR glasses, etc. Each client computing device may include, for example, user input devices such as cameras, microphones, joysticks, buttons, touch screens, etc., as well as a display, which could include, for instance, an LED, LCD, plasma screen, projector, etc.

Network 140 enables communications among the entities connected to them through one or more local-area networks and/or wide-area networks. In one embodiment, network 140 is the Internet and uses standard wired and/or wireless communications technologies and/or protocols. Data exchanged over the network 140 can be represented using technologies and/or formats including hypertext markup language (HTML), extensible markup language (XML), and/or JavaScript Object Notation (JSON). In addition, all or some of the transmitted data can be encrypted using conventional encryption technologies such as the secure sockets layer (SSL), transport layer security (TLS), virtual private networks (VPNs), and/or Internet Protocol security (IPsec). In another embodiment, the entities use custom and/or dedicated data communications technologies instead of, or in addition to, the ones described above.

Education platform 110 stores educational content items and serves these items to users of client devices 130 in accordance with some implementations. In the illustrated embodiment, the education platform 110 includes a content repository 120, a user information repository 125, a repository of user customizable hands gesture commands 190, and an educational content and learning activities engine 115, referred to as the education engine 115 hereafter. In some implementations (not illustrated), content repository 120 or a portion thereof, is provided by a third-party (not shown) and may be communicatively networked with education engine 115, such as, via network 140.

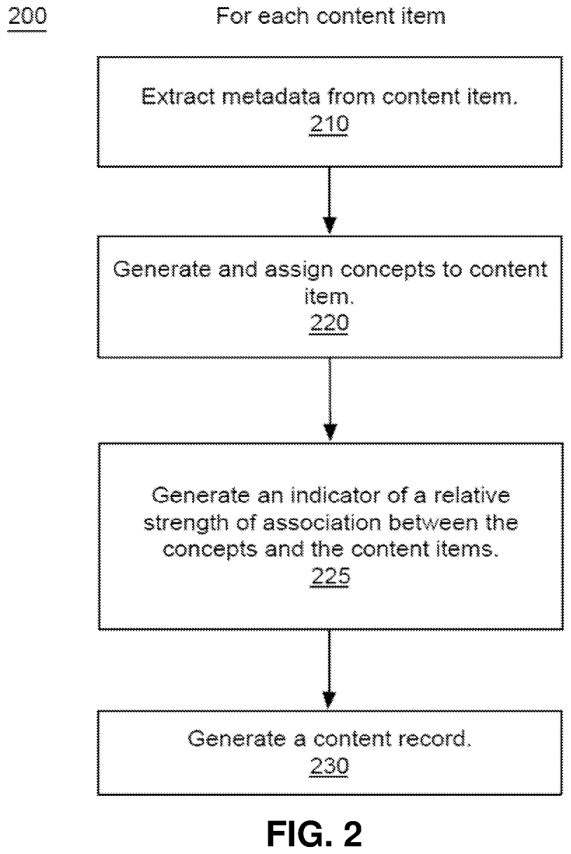

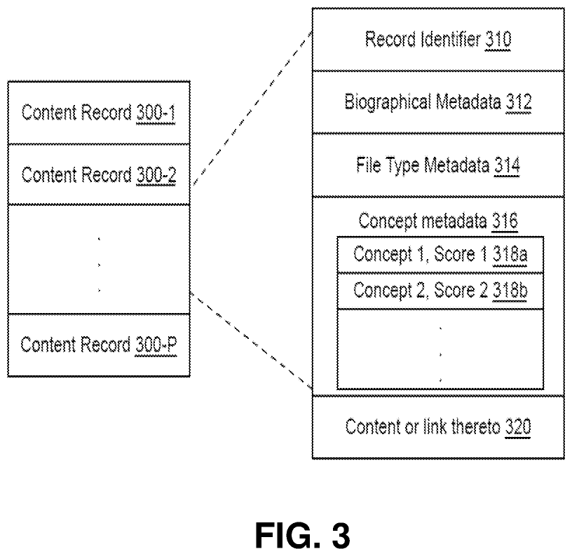

In some implementations, content repository 120 may store a collection of educational content from various sources from which content is selected for the AR overlay. In some embodiments, content repository 120 includes a number of content entities, each content entity including content of a similar type, such as textbooks, courses, jobs, and videos. Accordingly, a textbooks content entity is a set of electronic textbooks or portions of textbooks. A courses content entity is a set of documents describing courses, such as course syllabi. A jobs content entity is a set of documents relating to jobs or job openings, such as descriptions of job openings. A videos content entity is a set of video files. An image content entity is a set of images, such as JPEGs, PNGs, etc. Content repository 120 may include numerous other content entities, such as, a massive online open course (MOOC) content entity, a question and answer content entity, a user-generated content entity, white papers, study guides, or web pages. Furthermore, custom content entities may be defined for a subset of users of the education platform 110, such as sets of documents associated with a particular topic, school, educational course, or professional organization. The documents associated with each content entity may be in a variety of different formats, such as plain text, HTML, JSON, XML, or others. Content repository 120 is discussed further with reference to FIGS. 2 and 3. In some embodiments, content in the content repository 120 is acquired from professional content creators, such as book publishers, professors, teachers, production companies, record labels, etc., or from users 101, such as, when a user 101 uploads student notes, a draft of an essay, an assignment, etc. to education platform 110.

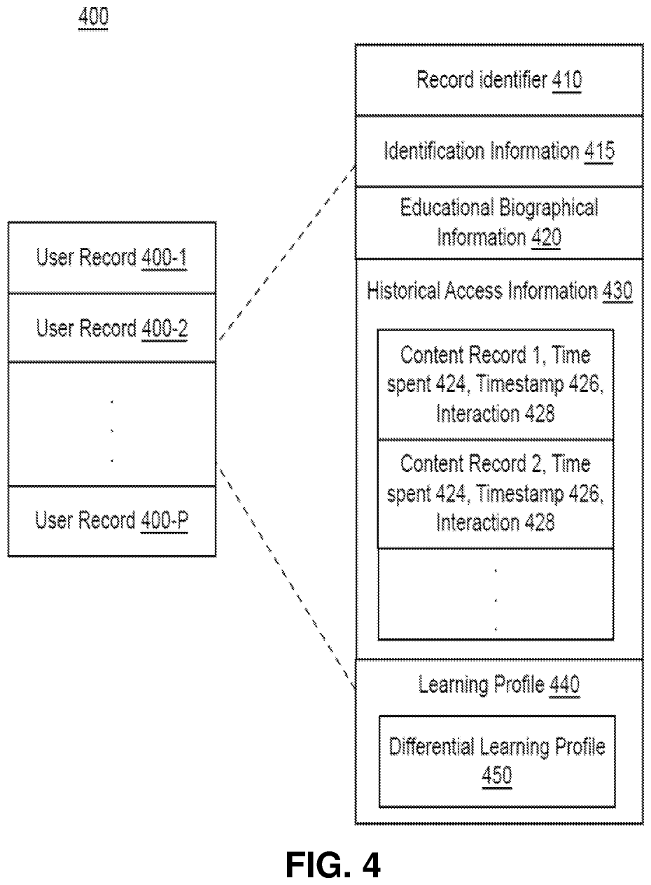

User information repository 125 stores information for each user of education platform 110, such as for users 101 and 102, and is discussed further with reference to FIG. 4.

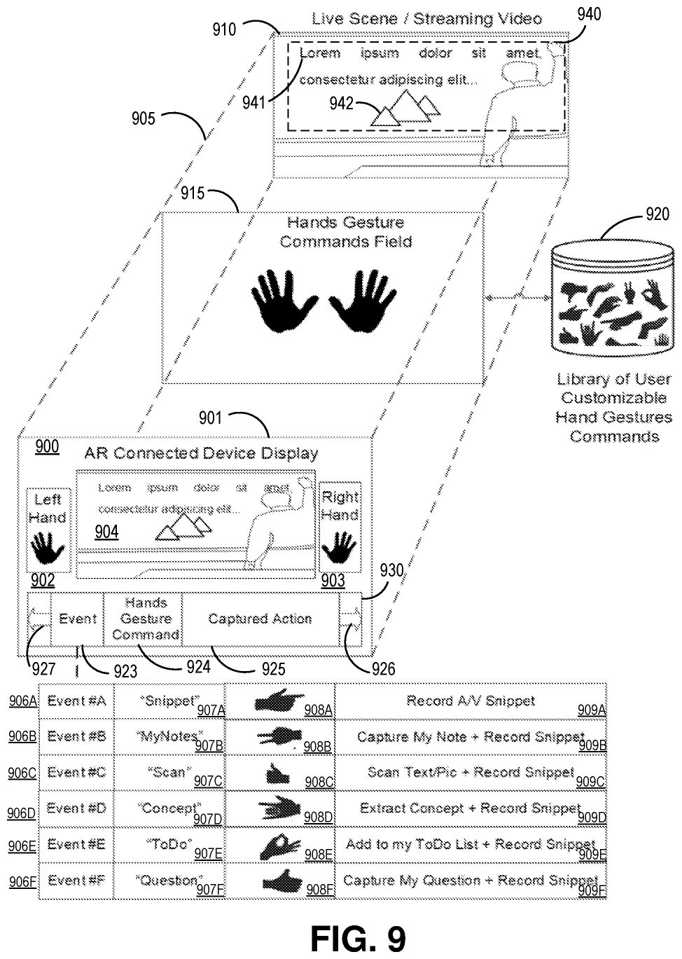

The repository of user configurable hands gestures commands 190 may store various hands gesture commands that have been defined by one or more users, such as user 102, and maintained by the education system 100. Thus, the education system 100 can implement a plurality of user customizable hands gesture commands that enable a user accessing the education platform 110, for instance user 102, to interact with the video lecture content and any supplement content simply by entering a hand gesture. In some implementations, each user customizable hands gesture command correlates a pre-defined and recognized hand gesture to the automatic execution of a particular series of actions performed by the command, such as automatically recording a snippet of the video lecture content, or automatically capturing a user-defined note. The user configurable hands gestures commands may be automatically executed on the client device 130b. The user configurable hands gestures command features of the education system 100 are discussed further in detail with reference to FIG. 9.

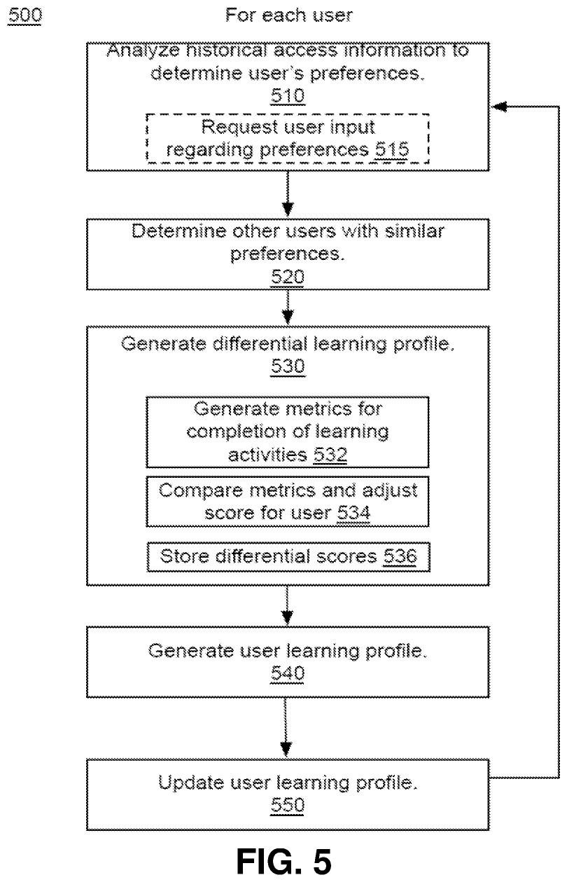

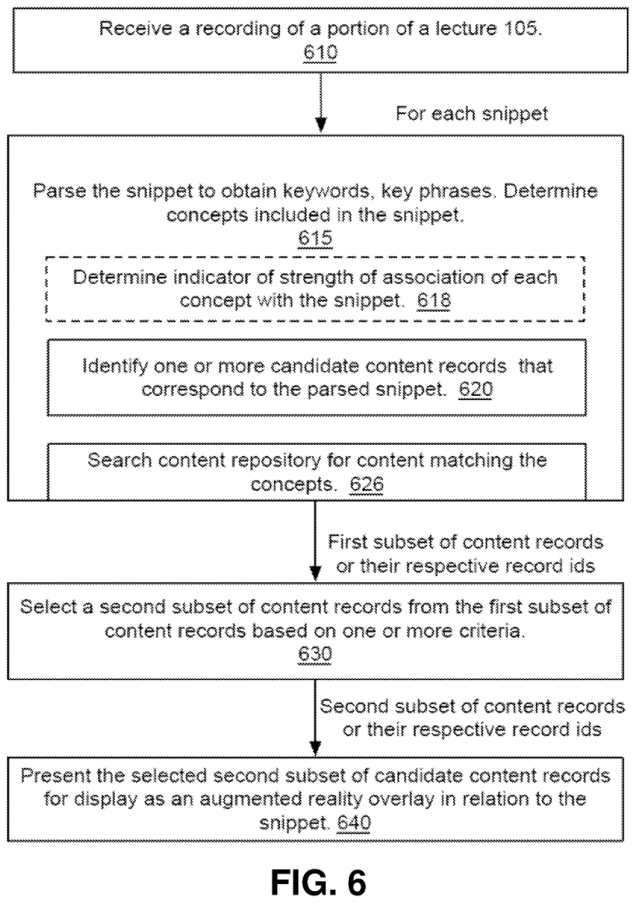

Education engine 115 provides personalized supplemental content for presentation in an AR overlay to users of education platform 110 and is discussed further with reference to FIGS. 3-8. In some implementations, education engine 115 employs Artificial Intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g., genetic algorithms), swarm intelligence (e.g., ant algorithms), and hybrid intelligent systems (e.g., expert inference rules generated through a neural network or production rules from statistical learning). Education engine 115 includes the following modules: content processing module 160, user learning profile module 170, and an overlay generation module 180. Content processing module 160 is discussed further with reference to FIG. 2. User learning profile module 170 is discussed further with reference to FIG. 5. Overlay generation module 180 is discussed further with reference to FIGS. 6-8.

Many conventional features, such as firewalls, load balancers, application servers, failover servers, network management tools and so forth are not shown so as not to obscure the features of the system. A suitable service for implementation of the education platform is the CHEGG [symbol] service, found at www.chegg.com; other education platform services are known as well, and can be adapted to operate according to the teaching disclosed here. The term “service” in the context of the education platform 110 represents any computer system adapted to serve content using any internetworking protocols and is not intended to be limited to content uploaded or downloaded via the Internet or the HTTP protocol. The term “module” refers to computer program logic for providing a specified functionality. A module can be implemented in hardware, firmware, and/or software. A module is typically stored on a computer-readable storage medium such as storage device, loaded into a memory, and executed by a processor. In general, functions described in one embodiment as being performed on the server side can also be performed on the client side in other embodiments if appropriate. In addition, the functionality attributed to a particular component can be performed by different or multiple components operating together.

While in this example, and in other examples throughout the disclosure, the multimedia lecture content captured by the client device 130 corresponds to lecture by an educator, it should be understood that the systems and methods described herein may be applied in any of a variety of other contexts, such as any multimedia recording that can be better understood if associated with an AR overlay of the multimedia lecture content. For example, the video recording may be a recording of a group meeting, such as a meeting of a student group, a meeting of co-workers discussing HR policies, etc. Content in the recording may be recognized and used to retrieve an augmented content overlay. For example, in the context of a meeting between co-workers in which a discussion of updating the existing HR policy page is happening, augmented content such as, a hyperlink to a HR policy page on the company's intranet, links to HR policies found online, notes from a previous meeting regarding the same topic, etc., may be overlaid in an AR overlay. Other use cases include live gaming events, live political rallies, live conference meetings, and other live events.

FIG. 2 is a flowchart illustrating a method 200 of processing content in content repository 120. Method 200 is performed, for example, by content processing module 160 of education engine 115. Steps in the method 200 that are not order-dependent may be reordered and steps may be combined or broken out.

At 210, content processing module 160 extracts metadata from content items in content repository 120, such as, title, author, description, keywords, file size, file type, language of content, publisher, and the like. As an example, for a particular book in content repository 120, extracted metadata may include: “Title: Science 101: Biology”, “Author: Ochoa, George”, “Edition: 1”; “ISBN-13: 978-0060891350”; “ISBN-10: 0060891351”; “Series: Science 101”; “Publisher: Harper Perennial”; “Language: English”; “Date of Publication: Jun. 26, 2007”; “File type: Pdf”; “File Size: 3 GB”.

At 220, content processing module 160 generates and assigns concepts to content items using a learned model, according to one embodiment. The learned model may be generated by a model trainer using an ensemble method, such as linear support vector classification, logistic regression, k-nearest neighbor, naïve Bayes, or stochastic gradient descent. As an example, for a particular chapter (say, chapter 1) in a particular book in content repository 120, content processing module 160 assigns the following concepts: process of science, macromolecules, cell, membranes, energy, enzymes, cellular respiration, and photosynthesis.

In some embodiments, concepts generated by content processing module 160 are hierarchical in nature, and the hierarchy is utilized when assigning concepts to a particular content item. For example, if content processing module 160 assigns a child concept is to a document, the corresponding parent concept is automatically assigned.

In some embodiments, concepts generated by content processing module 160 are seeded by information extracted at block 210. For example, say at 210, content processing module 160 extracts an index and a table of contents for a book. The information in the index and the table of contents is then used by content processing module 160 as seeds to generate the concepts assigned to that book.

In some embodiments, content processing module 160 identifies associations between concepts. Using the identified associations, content processing module 160 generates concept pairs, where concepts in a concept pair are related to each other. In one embodiment, content processing module 160 identifies associations between concepts based on a determination that two concepts frequently appear in proximity to one another in content items are likely to be related. Accordingly, in one embodiment, the content processing module 160 identifies associations between concepts appearing in proximity to one another in content items of the content repository 120, such as concepts appearing on the same page or concepts appearing in the same section of two documents. In one embodiment, the content processing module 160 applies an Apriori algorithm to identify concepts appearing in proximity to one another across multiple content items. Other algorithms identifying associations between concepts in the documents of the content repository 120 may alternatively be used.

In some embodiments, for concepts assigned to a particular content item, at 225, content processing module 160 also generates an indicator of a relative strength of association between the concepts and the particular content item. For example, for a first concept that is very strongly associated with the particular document, content processing module 160 may assign, say, a score of 0.99, while for a second concept that is only mildly associated with the particular content item, content processing module 160 may assign a score of 0.4.

In one embodiment, the content processing module 160 determines the indicators of relative strength (e.g., scores of 0 to 1) using one or more interestingness measures, such as support, confidence, lift, and conviction. The support supp(x) for a concept x is given by the probability P(x) of the concept occurring in a given document. The confidence conf(x→y) for a concept y occurring in a document given the occurrence of concept x in the document is defined by the conditional probability of y given x, or P(x and y)/P(x). The lift lift(x→y) for a concept y occurring in a document given the occurrence of concept x is given by the observed support for x and y in the document as a ratio of the expected support if x and y were independent concepts, or P(x and y)/[P(x)P(y)]. The conviction conv(x→y) is given by a ratio of the expected frequency of concept x occurring in a document without concept y (assuming x and y are independent concepts) to the observed frequency of x without y, or P(x)P(not y)/P(x and not y).

At 230, for each content item in the content repository 120, content processing module 160 generates a content record 300, which is discussed further with reference to FIG. 3. Concepts assigned at block 220 are stored as concept metadata 316.

The process shown in FIG. 2 is repeated until content records are created and concepts stored for content items in the content repository 120. Similarly, when new content is added to the content repository 120, the processing module 150 assigns concepts to these documents and creates corresponding content records by the process shown in FIG. 2. Further, as the learned model updates itself, concepts stored in the content records are also updated.

FIG. 3 depicts a block diagram for an example data structure for the content repository 120 for storing educational content and learning activity content in accordance with some implementations. Content repository 120 includes a plurality of content records 300-1 to 300-P, each of which corresponds to a discrete content unit. In some implementations, content repository 120 stores extremely large number of content records, such as in the millions, billions, etc. In some implementations, each content record 300 for a content unit includes: a unique record identifier 310 that identifies the particular content record; biographical metadata 312 associated with the content, such as, author, title, keywords, date of creation, date of upload to education platform 110, a description, a file size, and so on, as extracted at block 210; type metadata 314 associated with the content that identifies a type or format of the content, as extracted at block 210; concept metadata 316 determined by content processing module 160 at block 220 and optionally, indicators 318 of relative strength of association of concepts to the content in the content record; and content 320 or a link thereto.

Referring to type metadata 314, the type or format of a content unit is that of digital media and may include, without limitation, text content, image content (e.g., a JPEG or GIF file), audio content, video content, hypertext protocol content, and so on, or any combination of these kinds of content. Content may also include instruction-bearing content, such as machine-readable program code, markup language content, script content, and so forth.

Content record 300 also includes content 320. Content 320 may refer to a book of chapters (e.g., an “eBook”), a chapter of a book, a section within a chapter of a book (such as, questions at the end of the chapter), an issue of a magazine, an entire music album, a song in an album, user-generated notes, etc. In some implementations, the content record 300 does not include the content 320, but instead includes a pointer or link to or other address of content 320, in which case the content itself can be stored outside of the content repository 120, e.g., on a third party server or repository (not shown).

In some embodiments, one or more content records 300 can be broadly categorized as being one of a passive activity, a practice activity, and a user action activity. This category information may be stored as part of the record identifier 310.

Passive activities includes activities where users interact with reference materials to help the user understand the material being delivered by the lecture. Such reference materials may include a summary, excerpts from books, essays, online documents, lecture notes, a Khan Academy lecture, flashcards, etc.

Practice activities are testing activities that provide the user an opportunity to practice their mastery of a concept and/or test their knowledge, including such activities as assignments, quizzes, multiple-choice exams, and other testing materials. In some embodiments, an educator, such as the one providing the video lecture 105, provides the practice activity to be stored as a content record 100, thereby making sure that the user is paying attention and learning the material being presented by the video lecture 105. For example, the practice activity may be a multiple-choice quiz, such that when the user 101 provides answers to a multiple-choice quiz, those answers are stored and/or processed by educational platform 110, including by providing the user-generated quiz responses and/or a success score or rating to the educator.

Further, in some embodiments, user action content records 300 include user action content that specifies any action may be desired or required of the user. In some embodiments, user actions can be captured by the system from the user 101 or the educator presenting the lecture. Examples of user action content include open the textbook to a certain location, or creating an appointment, a reminder, or an automated email, etc. The appointment, reminder, etc. may be, for example, to turn in homework, open a particular page of book, read certain secondary sources, answer a particular quiz, send an email, and so on). The user 101 may also create a user-generated note corresponding to a particular snippet. The user-generated content may include voice notes, written notes, etc. The ability to add user-generated content that can be presented as an AR overlay on the snippet of the lecture to which the note user-generated content corresponds is an important aspect of the present disclosure.

Referring again to FIG. 1, educational platform 110 includes a user information repository 125, which stores a user record associated with each user (e.g., users 101 and 102) of education system 100. FIG. 4 depicts a block diagram for an example data structure for the user information repository 125 for storing user information for each user in some implementations. User information repository 125 includes a plurality of user records 400-1 to 400-P, each of which corresponds to a user 101.

A user record 400 may include: a unique record identifier 410 that identifies the particular user record; identification information 415 for the user, such as, the user's name, email address, address, mobile device number, etc.; educational biographical information 420; and historical access information 430 including records of user's activities on the educational platform 110.

Educational biographical information 420 may include historical and current biographical information, such as universities attended by the user, courses taken, grades in those courses, courses currently registered for, major(s) declared, degree(s) obtained, degree(s) user wishes to obtain, and so on.

Historical access information 430 indicates which content 320 (or associated content records 300 as identified by their unique content identifiers 310) in content repository 120 has been accessed by user 101. Access information 430 may also indicate amount of time spent 424 by user 101 on each content, and optional timestamps 426 of time of access. Access information 430 may also indicate attributes of interaction 428 by user 101 with content 322.

A user record 400 may further include a learning profile 440 for user 101. The determination of learning profile 440 by education platform 110 is described further with reference to FIG. 5. Learning profile 440 may indicate one or more preferred modes of learning for user 101 and may indicate preferences for: type of activity (e.g. passive, practice, etc.), type of content (e.g., video, lecture, book, etc.), duration of activity (short vs. long), and so on. For example, one user may learn better by watching videos, while another may learn better by reading text. In another example, one user may learn better if learning sessions are frequently interspersed with non-learning recreational sessions, while another may learn better with long undisturbed sessions. In another example, one user may learn better by repetition or refreshing of previously learned material, while another may prefer mostly or all new material. In yet another example, user 101 may have different preferred modes of learning for different subjects, courses, topics within a subject or course, or even concepts within a subject or course. In yet another example, user 101 may have different preferred modes of learning at different times. For example, at the beginning of an academic term, user 101 may prefer a first mode of learning (such as, a practice activity comprising refresh of material learned in a previous lecture, use of a lot of exercises to learn new topics), and at the end of an academic term, user 101 may prefer a second mode of learning (such as, a practice activity comprising refresh of material learned in current class).

In some embodiments, learning profile 440 optionally includes a differential learning profile 450. The determination of differential learning profile 450 by education platform 110 is described further with reference to FIG. 5.

FIG. 5 is a flowchart illustrating a method 500 of determining a user learning profile 430. Method 500 is performed, for example, by user learning profile module 170 of education engine 115. Steps in the method 500 that are not order-dependent may be reordered and steps may be combined or broken out.

In some implementations, learning profile module 170 generates a user learning profile using a learned model, according to one embodiment. The learned model may be generated by a model trainer using an ensemble method, such as linear support vector classification, logistic regression, k-nearest neighbor, naïve Bayes, or stochastic gradient descent.

At 510, learning profile module 170 analyzes a user's historical access information 430 to determine the user's preferences. The learning profile module 170 analyzes the user's activities (e.g., active, passive, or recall), type of content rendered (e.g., video, lecture, book, etc.), duration of activities, etc., to determine the user's preferences.

Optionally, at 515, learning profile module 170 may optionally request user 101 to provide user input regarding that user's preferences. In some implementations, learning profile module 170 requests user 101 to provide user input if there is not enough information in user's historical access information 430, as may be the case for a new or relatively new user 101 of education platform 110.

At 520, learning profile module 170 uses the user's preferences from 510 to determine other user records with similar preferences. In some implementations, learning profile module 170 compares the user's preferences with other users' preferences, and interprets a match over a certain threshold between these preferences as meaning that users have similar preferences.

At 530, learning profile module 170 generates a differential learning profile 450 for user 101. The differential learning profile 450 provides a snapshot of how the user's learning compares with one or more other users with respect to a particular subject, topic, course, concept, etc.

At 532, for two users (one of them being user 101), learning profile module 170 generates one or more metrics for completion of one or more sets of learning activities. Examples of metrics include: time taken to complete each learning activity individually; time taken to complete a particular set of learning activities in aggregate; completion velocity referring to whether the user started slowing but then got faster (i.e., accelerated), or started fast but got slow (i.e., decelerated), or stayed the same (i.e., no change); outcome of recall activities in the set of learning activities; outcome of the set of learning activities in aggregate (e.g., student grade); and so on.

In one case, users for generating the differential learning profile 450 are selected based on overlap in learning activities with user 101. Accordingly, differential learning profiles 450 are generated for users with overlap in learning activities. For example, say user 101 is enrolled (or was) enrolled in Bio 101. Accordingly, learning profile module 170 may generate a differential learning profile 450 for user 101 that indicates a difference between the user's learning and that of other users in Bio 101 based on all of the users performing the same activities, such as completing the same assignments, reading the same textbook chapters, and so on. In another case, the user for whom the metrics are generated refers to an average of metrics of all other users, say in Bio 101.

At 534, learning profile module 170 compares the metrics generated at 532 and adjusts a score for user 101 accordingly. The score may be incremented when the metric comparison indicates that user 101 performed better than the other user (or average user), decremented when user 101 performed worse, and not adjusted when the performances were equivalent. The score represents a difference between the learning profile for user 101 and one other user (or average user). Learning profile module 170 may iteratively perform steps 532 and 534 until it determines n differential scores for user 101 representing the difference between the learning profile for user 101 and each other user (n−1) who has completed the or more sets of learning activities at 532, such as each other user in Bio 101.

At 536, learning profile module 170 stores the n differential scores for user 101 as the differential learning profile 450 for particular subject, topic, course, concept, etc. In the example above, the n differential scores for user 101 are stored in association with the course Bio 101.

At 540, learning profile module 170 uses the user's preferences (from 510), the preferences for other similar users (from 520), and the user's differential learning profile 450 to generate a learning profile for the user. Accordingly, learning profile module 170 can expand and/or refine the learning profile for the user using the preferences for other similar users. For example, if a first user has learning preferences A, B, and C that match with a second user who also has learning preferences A, B, and C, but also has a learning preference D, then learning profile module 170 infers that the first user also has learning preference D.

At 550, learning profile module 170 updates the user's learning profile as the user's access information 430 changes, as other similar users' access information 430 changes, as new similar users are added, and as older similar users are no longer considered similar. At 540, learning profile module 170 also updates the user's learning profile based on results of an application of the user's learning profile. As discussed further with reference to FIG. 6, the user's learning profile is used to present a set of supplemental content to the user. In some implementations, the user's response to the supplemental content is stored as part of the historical access information 430 and is also used to update the user's learning profile.

The process shown in FIG. 5 is repeated until learning profiles are created and for each user record 400 in user information repository 125. Similarly, when new users access education platform 110 and corresponding new user records are added to the user information repository 125, the learning profile module 170 creates corresponding learning profiles. Further, as the learned model updates itself, learning profiles are also updated.

FIG. 6 depicts a method 600 of generating an AR overlay of supplemental content corresponding to a live video lecture 105 being watched by user 101. Method 600 is performed, for example, by overlay generation module 170 of education engine 115. Steps in the method 600 that are not order-dependent may be reordered and steps may be combined or broken out.

At 610, overlay generation module 170 receives a recording of a portion of a lecture 105. In some embodiments, user 101 makes a recording of at least portion of the lecture 105 using a video capture device, and accordingly, the recording of the portion of a lecture 105 is received by overlay generation module 170 of education engine 115. A live lecture corresponding to the video lecture 105 may be happening in a physical space, such as, classroom environment, an educator's home office, etc. User 101 may be physically present in the physical space and use their client device 130 to capture a recording of the live lecture, or the user 101 may not be physically present and in such a case, a video lecture 105 is delivered to clients 130 over network 150. As an example, users 101 and 102 may be students in a course, such as Geometry, and the live video lecture 105 may correspond to a lecture by a professor on the Pythagoras theorem. The user 101 uses a camera included in client 130 (or otherwise communicatively coupled to client 130, such as, via LAN, Bluetooth, etc.), to make a recording of the video lecture 105. In some embodiments, user 101 may use a camera-functionality of the same client device 130 to create a recording of the video lecture 105 as the one they are using to watch the lecture. In other embodiments, the user 101 may be watching the video lecture 105 using a first client device 130, such as, their laptop, and be making a video recording of the video lecture 105 using a second connected client device 130, such as their connected glasses, mobile device, etc.

As the user makes the recording, snippets of the recording are received at education platform 110. In some embodiments, the snippets are determined based on size. For example, as soon as a video recording reaches a pre-determined file size (e.g., 10 kb file size), it is transmitted by the client device 130 to education platform 110. As another example, in addition or in the alternative, as soon as a video recording reaches a pre-determined duration (e.g., 20 seconds long), it is transmitted by the client device 130 to education platform 110. In some embodiments, the pre-determined size or duration of snippet is small so as to enable near real-time transmission from the video capture device to education platform 110. In other embodiments, the snippets are selected by the user 101.

At 615, the snippet is parsed, such as by using video recognition tools, voice recognition tools, image recognition tools, etc. to obtain keywords and key phrases, as well as to identify concepts associated with the content in the snippet. In some implementations, overlay generation module 170 determines the keywords, key phrases, and one or more concepts using a learned model. The learned model may be generated by a model trainer using an ensemble method, such as linear support vector classification, logistic regression, k-nearest neighbor, naïve Bayes, or stochastic gradient descent. For example, a particular snippet may include content associated with the following concepts: process of science, macromolecules, cell, membranes, energy, and enzymes. In addition, the overlay generation module 170 determines the keywords, key phrases, and one or more concept based on the context of the snippet.

In some implementations, at 618, overlay generation module 170 optionally computes an indicator of a relative strength of association between the concepts and the snippet. For example, for a first concept that is very strongly associated with the snippet, overlay generation module 170 may assign, say, a score of 0.99, while for a second concept that is only mildly associated with the particular snippet, overlay generation module 170 may assign a score of 0.4.

At 620, overlay generation module 170 identifies one or more candidate content records 300 that correspond to the parsed snippet. The candidate content records may be identified based on machine learning, strength of association with one or more of the identified concepts, or any of a number of other techniques.

At 626, overlay generation module 170 searches content repository 120 for content that matches the one or more concepts from block 615. As discussed with reference to FIGS. 2 and 3, concepts metadata 316 is generated and stored for each content in content repository 120. At 626, overlay generation module 170 searches content repository 120 for content records that include the one or more concepts from block 615 in their concepts metadata 216. Continuing the previous example, at 626, overlay generation module 170 searches content repository 120 for content records that include these concepts in their concepts metadata 316: process of science, macromolecules, cell, membranes, energy, and enzymes. Result of the search at 626 returns a first subset of content records in content repository 120. In one case, the result of the search 626 is a list of record ids 310 for the first subset of records.

In some embodiments, the candidate content records are selected at least in part based on a preference or selection made by the person or entity providing the video lecture 105. For example, a professor may select a particular practice activity content record 100 for all users watching the video lecture. As another example, the professor may select different practice activity content records for the users watching the video lecture 105, thus making sure the users do not cheat and/or to personalize the practice activity, such as based on different users' ability, skill level, learning goals, grade level, etc. In some embodiments, the candidate content records are selected at least in part based on a match with a user profile associated with the user 101.

At 630, overlay generation module 170 selects a second subset of content records from the first subset of content records based on one or more criteria. Examples of criteria include: degree of match of a content record with the user's profile, degree of match of a content record, and so on.

As an example, say the result at 615 is a concept A, and the result at 630 is hundreds of content items. At 640, overlay generation module 170 selects four content items from the hundreds of content items. The four content items correspond to the concept A. In some implementations, the four content items are further selected, based, e.g., on course syllabus (and/or other course materials), similar courses, and/or the user learning profile indicating user's understanding of the concept is weak. In some embodiments, the four content items are further selected based on attributes of client device. For example, if the user 101 is using a mobile device versus a laptop, the four content items selected are those that are optimized for being rendered on a mobile device. In some embodiments, the four content items include items of different types (e.g., video, quizzes, textbook content, etc.).

In some embodiments, the four content items include items that have previously been accessed by user 101 and new items that have not previously been accessed by user 101, as indicated by user's historical access information 430. The ratio of previously accessed content and new content may be based on the user's learning profile (computed at 615).

At 640, overlay generation module 170 presents the selected second subset of candidate content records for display on the client device as an augmented reality overlay in relation to the snippet. For example, the candidate content records may automatically be displayed in a portion of a screen of the client device below, next to, over, or elsewhere in relation to the snippet.

As the user continues to render the video 105, the user may continue to select snippets for retrieving corresponding content. When the user moves on from one snippet to the next, the process 600 starts over at block 810. When the user selects the second snippet, the corresponding candidate records are provided for display on the client device as an augmented reality overlay in relation to the snippet.

The approach of the present disclosure can improve the efficiency of data processing by retrieving data associated with content and concepts in a snippet of a video lecture and presenting the data for display on the client device as an augmented reality overlay in relation to the snippet. By providing data in this manner, user may be quickly presented with additional information to facilitate understanding the content and concepts in the video lecture, without having to enter various search requests, look for particular websites, and sort through various irrelevant information. Accordingly, the user's experience is enhanced and more enjoyable.

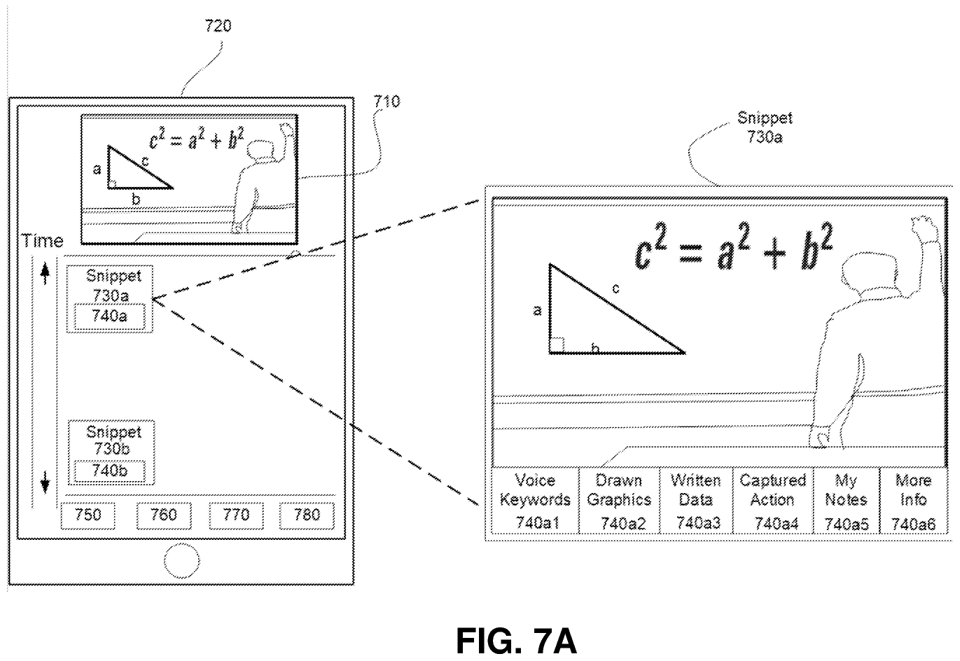

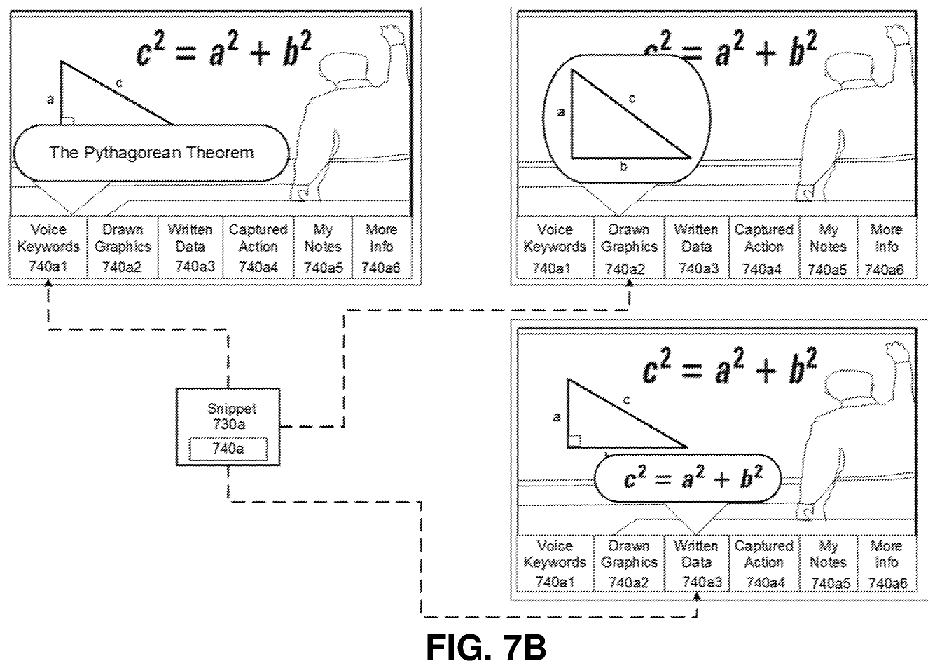

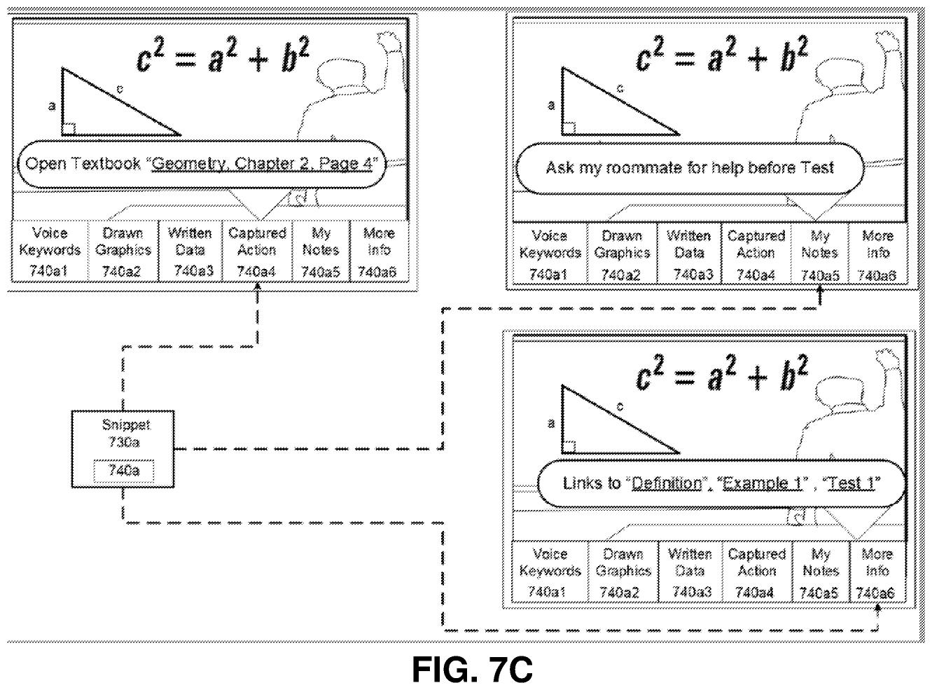

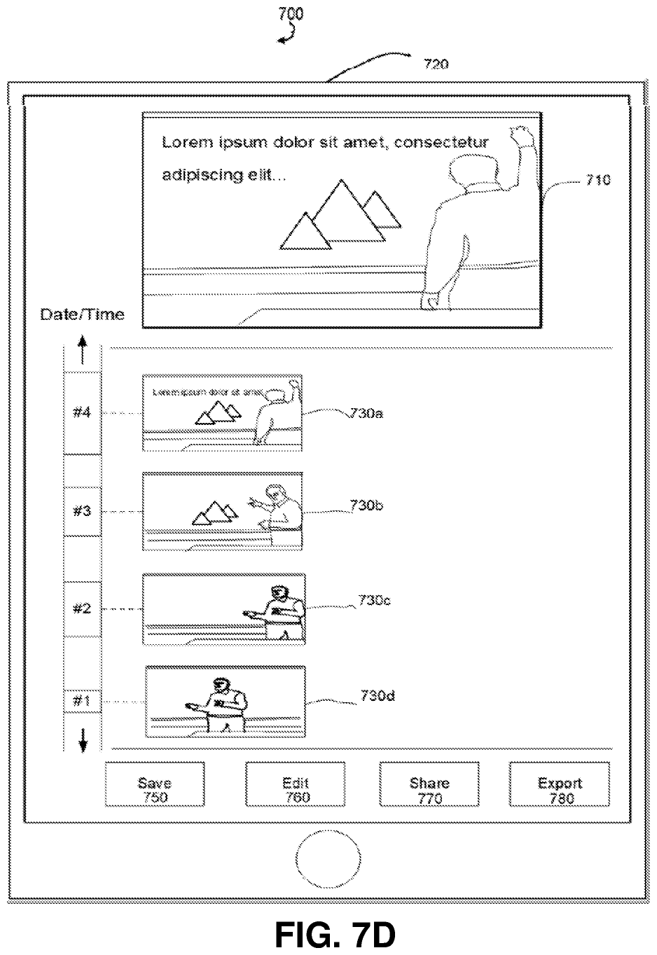

FIGS. 7A, 7B, 7C and 7D illustrate a user interface 700 for presenting supplemental content to a user watching a live lecture as an augmented overlay to a user 101 according to some embodiments.

As illustrated in a FIG. 7A, user 101 is watching an audio/video stream 710 on their client device 720. The user 101 has been watching the stream 710 for a little while and has created a first snippet 730. As an example, say that the audio/video stream 710 is at runtime of 22 minutes, snippet 730b may be two minutes long and correspond to the fifteenth to seventeenth minutes of the audio/video stream 710, while snippet 730a may be one minute long and correspond to the twentieth to twenty first minute of the audio/video stream 710. Accordingly, snippet 730a is the most recently created snippet, snippet 730b is the second most recently created snippet, and so on. Corresponding to each snippet 730 is respective supplemental content 740 that is presented as an AR overlay. Accordingly, if user 101 renders snippet 730b, corresponding supplemental content 740b is presented as an AR overlay on the snippet 730b. When user 101 renders snippet 730a, corresponding supplemental content 740a is presented as an AR overlay on the snippet 730a. In some embodiments, supplemental content 740 include content items that reflect differing types of user interactions. As an example, a first content item may be a passive activity involving the user looking at some information sourced from Wikipedia, a second content item may be a recall activity involving the user doing a quiz, a third content item is a recreational activity designed to help the student relax, and so on.

User interface 700 also provides various user interface actions or buttons. A “Save” button 750 may be used to save the snippets 730 and associated supplemental content 740, to one or more of: memory local to the client device 720, an online drive, in a folder associated with the course (e.g., Geometry course), etc.

A “Share” button 770 may enable the user to share one or more snippets 730 and corresponding supplemental content 740 with other users, such as with a user 102 in the user's (user 101) Geometry class. The shared content (a snippet and its corresponding supplemental content, such as notes generated by user 101) can be rendered by user 102 such the supplemental content is presented as an AR overlay over the shared snippet.

An “Export” button 780 may enable the user to export the one or more snippets 730 and corresponding supplemental content 740 to other file formats. In some embodiments, the “Export” button 780 may be used to package the one or more snippets 730 and corresponding supplemental content 740 for distribution and playback.

An “Edit” button 760 enables the user to edit a snippet 730 and/or corresponding supplemental content 740. Accordingly, the user may be able to use edit the presented candidate records once they have been provided for display on the client device as an augmented reality overlay in relation to the snippet. The user may wish to remove supplemental content that the user does not find helpful, or that does not otherwise appeal to the user. The “Edit” button 760 also enables the user to create additional snippets 730 with corresponding supplemental content 740. The “Edit” button 760 also enables the user to delete existing snippets 730 and corresponding supplemental content 740. The user may also be able to request additional candidate records if the quantity or quality of presented candidate records is insufficient. In some embodiments, the request for addition of additional supplemental content records is fulfilled by overlay generation module 170. In other embodiments, the user 101 may also be able to add user-generated content as a candidate record. For example, the user 101 may wish to add their notes corresponding to a particular snippet. The user-generated content may include voice notes, written notes, etc. The ability to add user-generated content is an important aspect of the present disclosure.

As illustrated in FIG. 7B, the user has watched some more of the video lecture 710 and has created four snippets, each with corresponding supplemental content that is presented as an AR overlay. In FIG. 7B, there is additional supplement content that can be presented as an AR overlay corresponding to the particular snippet. For example, the interface 700 includes user interface actions or buttons, including “Voice Keywords” 740a1, “Drawn Graphics” 740a2, and “Written Data” 740a3 which may be used to present the corresponding supplemental content for the snippet.

As illustrated in FIG. 7C, there is additional supplement content that can be presented as an AR overlay corresponding to the particular snippet. For example, the interface 700 includes user interface actions or buttons, including “Capturing Action” 740a4, “My Notes” 740a5, and “More Info” 740a6 which may be used to present the corresponding supplemental content for the snippet.

As illustrated in FIG. 7D, there are multiple snippets 730a-730d that can be presented to the user. Corresponding to each snippet 730a-730d can be respective supplemental content that is presented as an AR overlay.

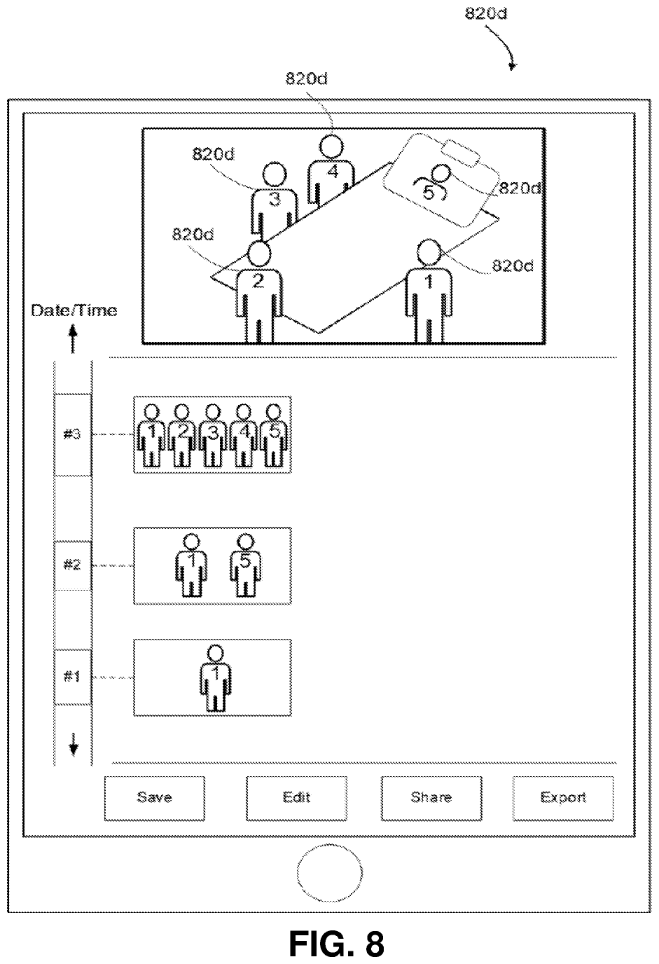

FIG. 8 illustrates a user interface 800 for presenting supplemental content to a user participating in a live video conference meeting as an augmented overlay according to some embodiments. The interface 800 is similar to interface 700. As illustrated in FIG. 8, while participants 820a-d in the live video conference meeting are physically in the same conference room, while participant 820e is attending virtually. In fact, none of the participants need to be physically co-existent. Snippets 830 may correspond to important events in the meeting, such as, when agenda items are discussed, action items are discussed, decisions are made, and so on. In some embodiments, the supplemental content 840 corresponding to the snippets 830 may include content such as, content relevant to a topic in the snippet, as may be obtained from company documents, Intranet, Internet, etc., user generated content such as meeting notes, user bios, and so on. For example, in the context of a meeting between co-workers in which a discussion of updating the existing HR policy page is happening, augmented content such as, a hyperlink to a HR policy page on the company's intranet, links to HR policies found online, notes from a previous meeting regarding the same topic, etc., may be overlaid in an AR overlay 840.

Referring now to FIG. 9, an example of an interface 900 that is employed for interacting with video lecture content and supplemental content using user customizable hands gesture commands entered by a user is illustrated. As seen in FIG. 9, a streaming video (or live scene) 910 of a lecture can be presented at a distance away from an AR connected device display 901. For instance, a user may view a streaming video of a live lecture that also includes supplemental content that is presented as an AR overlay. Thus, the streaming video 910 can be presented as an AR environment, having computer-generated simulations that integrate the real world and virtual spatial dimensions. In the example of FIG. 9, the AR environment can present the streaming video 910 of the live lecture having the lecturer and whiteboard at a perceived distance away from the user (with respect to the user's visual perspective) in a manner similar to a student that is physically present at the live lecture (e.g., seated in a lecture hall) in a real world environment. With this perceptual distance, a field 905 is formed between the AR connected device display 901, such as a display screen of a smartphone, and the presented streaming video 910 of the lecture and any AR overlay, as viewed by the user. Thus, a user can place their hands within the field 905, such that either a left hand, a right hand, or both hands are in front of the AR connected device and can be visually captured by an image capturing device (not shown). In some implementations, the image capturing device is a component of the AR connected device, such as a digital camera embedded within a smartphone. Alternatively, the image capturing device can be implemented as standalone device that can operate in connection with the AR connected device display 901. A particular area within the field 905 that enables a user's hand(s) to be captured and accurately recognized by the image capturing device is referred to herein as a hands gesture command field 915.

Accordingly, as a user moves their left hand, right hand, or both hands within the hands gesture command field 915, the image capturing device can detect this movement of the user's hand(s) to recognize if the fingers (and palms) are positioned in a particular gesture that is intended to convey information, namely a hands gesture command. For example, the user may place their left hand within the hands gesture command field 915, and motion their hand by extending the index finger outward, extending the thumb upward (contracting the other fingers inward to touch to inside of the palm), and facing the palm inward (e.g., towards the AR connected device display 901). The user's hand gesture can be captured, for example, by a front-facing digital camera of the smartphone. By capturing and analyzing the imaging of the user's hand motion within the hand gestures command field 915, the hand gesture made by the user can be recognized by the system as representing a corresponding hands gesture command that has been previously defined by the user and maintained by the system (shown as library of user customizable hands gesture commands 920). According to the embodiments, the system can implement a plurality of user customizable hands gesture commands, where each user customizable hands gesture command correlates the system's recognition of a hand gesture (captured within the hands gesture command field 915) to the automatic execution of a particular action that allows the user to interact with the streaming video 910 and any supplement content. Consequently, a user can interact with the streaming video 910 of the live lecture, for instance initiating a recording of a snippet of the streamed lecture, simply by moving their hand(s) within the hands gesture command field 915 which automatically executes the user-customizable hands gesture command.

The user customizable hands gesture commands feature enables the quick launching of various actions for interacting with the streaming video 910, including, but not limited to: recording a snippet of the video lecture content; capturing a note; and optically scanning text or pictures recognized within the video lecture content. Enabling a user to interact with the capabilities of the system in a fast and efficient manner is crucial within the time-critical context of education and training. Generally, if the user is distracted for any significant amount of time, attention is taken away from the content of the lesson. For instance, when a student has to direct their eyes and attention away from the lecturer to manually write-down notes, this increases the likelihood that the student may miss important information while it is being presented during that time in the lecture. In many cases, even if a student uses electronic mechanisms (as oppossed to manual) such as typing a note using a word processing application on their smartphone, the student still needs to navigating through multiple user interfaces and/or selecting a series of individual inputs, which may interrupt the user's focus to the lecture itself, and prevent the user from gaining a full enrichment from the learning experience. The user customizable hands gesture commands, as disclosed herein, address this issue by significantly reducing the amount of time and effort required by the user to interact with the video lecture content, thereby eliminating distractions and interruptions from the actual lecture. The user customizable hands gesture commands are configured to quickly and automatically launch the actions and applications needed to by the user to interact with the video lecture content, requiring minimal input by the user, namely a simple hand gesture.

As seen in FIG. 9, the system can include a library of user customizable hand gestures commands 920, which is the set of commands that define the one or more hand gestures that are recognizable to the system, and the specified action(s) that each defined hand gesture evokes. In some implementations, the library of user customizable hand gestures commands 920 is maintained as a repository on the education platform (shown in FIG. 1). Referring to the example above, a user customizable hands gesture command can define that extending the index finger outward, extending the thumb straight upward (contracting the other fingers) as a particular hand gesture that is recognized and interpreted by the system (e.g., indicating that an action is to executed). Further, the library of user customizable hand gestures commands 920 can include that the action(s) corresponding to this hand gesture is defined as recording a snippet. As a result, when the user places a hand in the hand gestures commands field 915 and motions this particular hand gesture, the system recognizes this as the defined “snippet” user customizable hands gesture command, and automatically performs the command's action, and starts to record a snippet of the streaming video 910 of the lecture. In the illustrated example, the library of user customizable hand gestures commands 920 comprises a plurality of commands that are defined by the user, including but not limited to: a “Snippet” command, which initiates recording of a snippet of a streaming video (or live scene); a “MyNotes” command, which captures a user-generated note associated with a section of a streaming video (or live scene); a “concept” command, which extracts a concept related to, or presented within, a section of a streaming video (or live scene); a “ToDo” command, which adds action content, such as a reminder or task to a section of a streaming video (or live scene); and a “Question” command, which captures a question from a user that is related to a section of a streaming video (or live scene). Each of these aforementioned user customizable hands gesture commands are discussed in greater detail below. It should be appreciated that the user customizable hands gesture commands that are described herein are for purposes of illustration, and are not intended to be limiting. Accordingly, the disclosed embodiments can implement other user customizable hands gesture commands in addition to those previously described, as deemed necessary and/or appropriate. The user customizable hands gesture commands can incorporate commands, user action content, user interactions, and activities that are pertinent to interacting with streaming video 910 and the supplemental content within the context of learning and education.

The user customization is a key aspect of the user customizable hands gesture commands, as disclosed. In some implementations, the system can be configured to include one or more default hands gesture commands. However, relying only on default hands gesture commands may not be most suitable for the unique needs and characteristics of a particular user, and thus may be less optimal for specific users when interacting with the streaming video 910 and supplemental content. Therefore, the configuration of the commands that are included in the user customizable hands gesture commands library 920 can be distinctively customized by a user. That is, the commands in the library of user customizable hands gesture commands 920 can be defined by the user, and thus adapted to the characteristics of that specific user, ultimately increasing optimization of the feature. As an example, a user may have a dominant hand, for instance being left-handed, making hand movements with the left hand much easier for the user in comparison to the right hand. It may be desirable in this scenario for the user to define user customizable hands gesture commands that recognize hand gestures made with the left hand (as opposed to the right hand). As another example, a user may have a hand that is best suited for dictating hand gestures. For instance, the user may typically hold a pen in their right hand (e.g., for note taking), which predominately leaves the left hand to be readily available for entering hand gestures. Consequently, it may be desirable in this scenario for the user to define user customizable hands gesture commands that recognize hand gestures made with the left hand (as opposed to the right hand, or both hands).

Further, in some cases, there may be a subset of actions that are used more frequently by a particular user than other actions. Thus, it can be more important to define user customizable hands gesture commands that execute the frequently performed actions in this subset, for that particular user. For example, a user may frequently record snippets of their viewed lectures, but very rarely raises questions. Accordingly, the library of user customizable hand gestures 920 can be customized by the user to include the “Snippet” command and remove the “Questions” command. Other characteristics of the user may be used to govern the customization and/or configuration of the library of user customizable hands gesture commands 920. In addition, the hand movements used to indicate a hands gesture command may be hand movements that are deemed as uncommon, in order to mitigate the user making an arbitrary hand motion that inadvertently enters a command to the system. For example, a hand waving motion may not be deemed suitable for implementing a user customizable hands gesture command, as it may be common for a user to wave at another person or to unconsciously move their hand in a waving motion. A memory, repository, database, or storage system, such as one or more storage devices remotely located from the AR connected device can be employed to implement the library of user customizable hand gestures 920, such as the education platform (shown in FIG. 1). In some embodiments, the library of user customizable hand gestures commands 920, either partially or in its entirety, may be implemented as memory, such as a non-transitory computer-readable storage medium, that is local to the AR connected device.

FIG. 9 illustrates the user interface 900 that can be employed by a user to control the abovementioned hands gesture commands capability of the system. As seen, the user interface 900 may be comprised of multiple interface elements 902-904, 923-927, and 930. Each of the interface elements 902-904, 923-927, and 930 serve as an interactive component, having a respective function that allows the user to track, control, and interface with the hands gesture commands, as well as the streaming video 910 and supplemental content. Particularly, FIG. 9 shows the user interface 900 including: a content window 904 in the center of the interface; two hand place holders 902, 903 on opposing sides of the content window 904; and a hands gesture history tracking window 930 positioned at the bottom of the interface 900 below the place holders 902, 903 and the content window 904. It should be appreciated that the configuration of the user interface 900 shown in FIG. 9 is an example for purposes of illustration, and it not intended to be limiting. Accordingly, in some embodiments, the user interface 900 may include elements and have an arrangement that is different from the example shown in FIG. 9

The content window 904 serves as a display, mirroring the content of the streaming video (or live scene) 910 that is being viewed by the user. Thus, the streaming video 910 can be rendered on the AR connected device display 901 simultaneously as the user watches the streaming video 910 and the supplemental content in an AR environment, or a live scene in a real-life environment.

Additionally, the hand place holders 902, 903 each display a rendering of the user's hand as it is captured by the image capturing device of the AR connected device. The hand place holder 902 that is positioned on the left side of the content window 904 is dedicated to rendering the left hand of the user in the user interface 900, and the hand place holder 903 that is positioned on the right side of the content window 904 is dedicated to rendering the right hand of the user in the user interface 900. Accordingly, the hand place holders 902, 903 allow the user to view a visual representation of the particular movement and/or of gesturing of the left hand, right hand, or both hands, from the perspective of the image capturing device. For example, the user can move their left hand within the hand gestures command field 915 in order to execute a specific hands gesture command, but the user may also see that only a portion of their left hand is shown in the hand place holder 902. By viewing their hand in the same manner it is being captured by the image capturing device, the user becomes aware that their left hand may not be in an optimal position within the hand gestures command field 915 (e.g., entirely within the range of the image capturing device lens) to enable the image capturing device to fully recognize their hand gesture and for the system to accurately execute the appropriately corresponding hands gesture command. Referring back to the example, subsequent to viewing the rendering of their hand(s) in the hand place holders 902, 903, the user can then reposition their hand(s) as necessary within the hand gestures command field 915 to ensure that the hand gestures are appropriately recognized by the image capturing device, and the intended hands gesture commands are performed by the system. Consequently, the hand place holders 902, 903 can serve as a performance enhancing feature provided by the user interface 900, preventing some user error (e.g., hand gestures not being properly captured by the image capturing device) and misinterpretation of the user's hand gestures by the system.

In FIG. 9, the hand gesture history tracking window 930 is illustrated to display a historically tracked list of events 906A-906F. The events 906A-906F can be records generated by the system in response to recognizing various hands gesture commands entered by the user. For instance, after a hand gesture is captured and interpreted by the system, an event may be recorded and displayed by the interface 900 within the hand gesture history tracking window 930, which allows the user to have visible representations that serve as a historical tracking of hands gesture commands that have been performed by the system over a time period. As an example, the events 906A-906F shown are displayed in an ascending order with respect to a time that has elapsed since the captured event was entered into the system by the user. That is, in the example of FIG. 9, the most recently captured event (e.g., shortest time elapsed since capture) is displayed at the top of the list, and the oldest event (e.g., longest time elapsed since capture) is displayed at the bottom of the list within the hand gesture history tracking window 930. Accordingly, event 906A, illustrated as “Event A”, may be the most recent event recorded by the system, and event 906F, illustrated as “Event F”, may be the oldest event recorded by the system. In some embodiments, one event is displayed within the hand gesture history tracking window 930 at a time. Thus, a user may scroll through the events 906A-906F arranged in the historical list, for example, navigating through the list in the interface 900 in order to view the respective event inside of the hand gesture history tracking window 930. As a result, the user can view, and ultimately track, the records of events 906A-906F corresponding to the various hand gestures that have been performed. In some implementations, the events 906A-906F may be displayed within the hand gesture history tracking window 930 in a horizontal arrangement where each of the events 906A-906F are positioned to the side of (e.g., to the right or the left) of a consecutive event in the list (rather than above or below). For example, the event 906A (“Event A”) may be displayed at the left most section of the gesture history tracking window 930, and the user can scroll in either direction, for instance selecting right arrow 926 to scroll right or left arrow 927 to scroll left within the window 930 to navigate through the list, in order to view the successive events 906B-906F in the window 930.

Each of the events 906A-906F displayed in FIG. 9 can be displayed by the interface 900 as an event 923 associated with: (1) a corresponding hands gesture command 924, which is entered by the user in accordance with the hands gesture commands capability of the system; (2) a captured hand gesture, based on the movement of the user's hand within the hands gesture commands field 915; and (3) a captured action 925 that is performed based on the entered hands gesture command.

In FIG. 9, event 906A (“Event A”) corresponds to the “Snippet” hands gesture command 907A that causes the AR connected device to record an audio/visual (A/V) snippet as the captured action 909A. The snippet hands gesture command 907A allows a user to motion their hand inside of the hands gesture commands field 915 into the defined hand gesture that the system is set to recognize, which automatically triggers the AR connected device to start recording an A/V snippet of the streaming video 910. Details regarding creating snippets of video lecture content are previously described with respect to FIG. 6, and thus are not extensively described again in reference to FIG. 9 for purposes of brevity. As seen in FIG. 9, a hand is illustrated with an index finger extended (to the right), and the thumb pointed upwards (with the remaining fingers folded against the inside of the palm) as the captured hand gesture 908A that the system can recognize and interpret to execute the corresponding snippet hands gesture command 907A.

In an embodiment, the snippet hands gesture command 907A is configured to automatically record a snippet for a pre-defined amount of time (e.g., one minute), and consequently does not require an additional hands gesture command (or hand gesture from the user) to stop the recording. In other words, a single hand gesture from the user can automatically trigger the system to start recording a snippet and to stop recording the snippet. In a scenario where the duration for recording the snippet using the snippet hands gesture command 907A automatically ends, and the user desires more of the video lecture content to be recorded, the user can continue recording by making additional hand gestures that enter one or more subsequent snippet hands gesture commands into the system in order to record consecutive snippet(s). These successively recorded snippets can later be viewed in succession by the user as a continuous recording, which is substantively equivalent to a snippet of a longer duration from the perspective of the user. A default duration for the snippet that is recorded using the snippet hands gesture command 907A may be set in the system. The user may also set a user generated duration for the snippet, so as to modify the amount of time the snippet hands gesture command 907A records the streaming video (or live scene) 910 to be better suited to the needs of the user and/or the learning environment. For instance, it may be desirable for the user to set a user generated duration for a snippet (e.g., three minutes), which is longer than the default duration, if the user prefers more context around the certain concept that is being presented by the lecturer in the snippet.

Alternatively, the system may include an end snippet hands gesture command that can be used in conjunction with the snippet hands gestures command 907A in order to terminate the snippet, which would allow the user more control with respect to determining the duration of the snippet. As an example, a user could enter the end snippet hands gesture command 30 seconds after triggering the recording of the snippet by the snippet hands gesture command 907A, if the lecturer quickly defines a term or quickly explains a simple concept.

Accordingly, a snippet of the streaming video 910 that is being watched by the user through the AR connected device can be created by a simple hand motion of the user. The snippet hands gesture command 907A provides efficiency and ease of use, as it does not require the user to navigate through various interfaces and/or interact with mechanical buttons on the AR connect device that otherwise would be used to select a recording feature. For example, on a smartphone, a user may have to navigate through various applications or settings on the device to find the specific interface for controlling the camera, open the interface, and then touch the screen of the smartphone (or press a button on the smartphone) to select the record function of the camera before recording begins. In a learning environment, where capturing information that is being presented by the lecturer is time critical, supporting a snippet hands gesture command 907A that records using a seamless automated interaction, can mitigate loss of critical information and/or key concepts of the lecture that may be experienced when employing slow and cumbersome input mechanisms for recording.

In addition, FIG. 9 illustrates event 906B (“Event B”) as being listed within the hand gesture history tracking window 930. The event 906B corresponds to a “MyNotes” hands gesture command 907B that enables a defined hand gesture to be entered by a user, which automatically launches an application for creating a user-generated note. The user-generated note may correspond to a portion of the streaming video 910. As an example, at a point during the lecture, the lecturer may mention notable information, such as a date for a test, an assigned reading from specific chapters of a text book, an assignment with an upcoming due date, and the like. The user can simply use a hand motion to execute the MyNotes hands gesture command 907B, while watching the streaming video 910, to automatically launch an appropriate application on the AR connected device for creating a note that references the important information mentioned in that part of the lecture. As alluded to above, there is a certain time-criticalness that is associated with capturing information in a learning environment. The amount of time that a student is distracted while having to manually write down notes (e.g., pen and paper) about a key point, or navigate through multiple windows on a client device to generate a note in an electronic form can lead to them missing other important concepts as the lecture continues. In other words, in the context of a lecture, a note should be composed quickly to be the smallest interruption to a student's learning as possible. The MyNotes hands gesture command 907B implements a capability that is particularly meaningful to the learning environment, by allowing a user to automatically start creation of a note in an automated, fast, and efficient manner.

The MyNotes hands gesture command 907B is configured to allow a user to move their hand inside of the hands gesture commands field 915 forming the defined hand gesture 908B that the system recognizes. Once the system interprets the captured hand gesture 908B, it can execute the MyNotes hands gesture command 907B, which automatically triggers the AR connected device to perform the corresponding captured action, namely capturing a note and recording a snippet (of the streaming video 910) as the captured action 909B. An example of the defined hand gesture 908B that is recognized by the system for executing the MyNotes hands gesture command 907B is shown in FIG. 9. In the example, the captured hand gesture 908B is shown as a hand with an index finger and a ring finger extended (to the left), with the remaining fingers folded against the inside of the palm. Thus, when the user makes this hand gesture 908B inside of the hands gesture commands field 915, the system can capture and interpret the gesture 908B, and subsequently executes the MyNotes hands gesture command 907B. As illustrated in FIG. 9, the MyNote hands gesture command 907B can automatically trigger creation of a note, as well as a recoding a snippet of the streaming video 910 that the user is viewing at that time. This provides the added benefit of having a video snippet that accompanies the user-generated note, allowing the user to be able view the snippet at a later time, and see the particular portion of the live lecture that provides context for the user-generated note. According to the embodiments, the MyNote hands gesture command 907B generates a snippet of the streaming video 910 in the same manner as the snippet hands gesture command 907A.

In some embodiments, the user-generated note can be a voice note, a hand-written note (e.g., a passive/capacitive stylus entry on a touchscreen), or a typed note. Thus, the MyNotes hands gesture command 907B may automatically launch a voice recognition/recording application (e.g., voice memo), a hand writing application (e.g., stylus compatible app), or a word processing and/or text entry application on the AR connected device based on the type of note that is desired to be created by the user. Even further, the type of note (and correspondingly the application used to generate that note) can be based on the particular gesture that is captured. Thus, in some embodiments, there may be several variations of gestures that trigger the MyNote hands gesture command 907B. For instance, there may be a specific gesture that is configured to trigger the MyNote hands gesture command 907B for generating a voice note. Thus, in response to capturing and recognizing the gesture that corresponds directly to a voice note, the system can automatically open a voice recognition/recording application which allows the user to quickly generate the voice note. As another example, there may be a different gesture that is particularly configured to trigger the MyNote hands gesture command 907B for a text note. Consequently, in response to capturing and recognizing the gesture that particularly corresponds to a text note, the system will automatically launch a word (or word processing) application that is used for creating the text note.

An event 906C (“Event C”) is also shown in FIG. 9 to be included in the list of the hand gesture history tracking window 930. The event 906C is associated with a “Scan” hands gesture command 907C that automatically scans information, such as text or images/pictures, within a specified frame of the streaming video 910. For example, when a user makes a hand motion within the hands gesture command field 915 that the system recognizes as the defined hand gesture 908C, then the scan hands gesture command 907C can be executed. Subsequently, the scan hands gesture command 907C can cause the AR connected device to scan a text/pic and start recording a snippet (of the streaming video 910) as the captured action 909C. Scanning can involve the AR connected device activating its image capturing device, such as an embedded digital camera of a smartphone, to automatically capture an image of a region within the streaming video 910 that serves as a scan of a specified frame of the streaming video 910 that is being view by the user. The specified frame 960 of the streaming video 910, in the example of FIG. 9, includes a whiteboard that is being used by the lecturer during the live lecture. Consequently, the resulting scanned image enables text recognition and/or image recognition analysis of the scan to be executed, and data that is recognized as text within the scanned image. The content within the frame 940 of the streaming video 910, which is text 941 and geometric FIG. s 942 that are written on the whiteboard by the lecturer in FIG. 9, can be captured in an automated manner by employing the scan hands gesture command 907C.

An example of the defined hand gesture 908C that is recognized by the system for executing the scan hands gesture command 907C is shown in FIG. 9. In the example, the captured hand gesture 908C is illustrated as a right hand with the thumb extended straight upwards, and the remaining fingers folded against the inside of the palm, which is commonly known as a “thumbs-up” hands gesture. Thus, when the user makes this hand gesture 908C inside of the hands gesture commands field 915, the system can capture the movement and interpret it as the known captured hands gesture 908C to execute the scan hands gesture command 907C.

The scan hands gesture command 907C leverages hand gesture capabilities to quickly scan text/pic information that is being viewed in a live stream, in a manner that is particularly useful in the learning environment. For example, by making a simple hand gesture, the user can immediately trigger a scan of a region within a current frame of the streaming video 910, which ultimately captures a complex equation, a definition, a graph, a figure, a table, a slide, and the like that may be written on the whiteboard, or other display means employed by the lecturer. In contrast, a student's concentration and time would be taken away from the other content presented in the lecture in order for a student to copy down the displayed text/pic information by hand. Furthermore, the scan hands gesture command 907C may also realize advantages associated with capturing data in an efficient and automated manner, for instance mitigating human error and inaccuracies that may occur when a student is attempting to quickly copy information presented during a lecture, such as an equation written on the whiteboard by the lecturer. The potential for human error may be exacerbated by other conditions in the learning environment, such as the student being partially distracted by continuing to listen to the lecture, which can lead to errors and inaccuracies in manually copying the information. A student capturing inaccurate information can have determinantal effects. As an example, the student may study and attempt to apply an equation presented during a lecture that has been incorrectly written down. By implementing a hand gesture that performs an automated scan of text/pic data, the overall enrichment from the student's learning environment can be improved.

The resulting scanned text/pic data captured using the scan hands gesture command 907C can be presented to the user, for instance within a separate window of the interface 901 or stored by the system as a file. In some embodiments, the scan hands gesture command 907C is configured to automatically scan text/pic content and start recording a snippet of the streaming video 910. The scan hands gesture command 907C can record a snippet of the streaming video 910 in the same manner as the snippet hands gesture command 907A, described in detail above. Also, in some embodiments, the text recognition implemented by the scan hands gesture command 907C, after the image of the frame is captured, can include text analysis techniques, such as Optical Character Recognition (OCR) that performs the conversion of images of typed, handwritten or printed text into machine-encoded text, from various sources, such as a scanned video, image, live scene, or document. The scan hands gesture command 907C can also implement picture recognition techniques, for instance an analysis of an image that can recognize and/or extract geometric forms, graphs, pictures, and the like from the image.

Additionally, yet another event 906D (“Event D”) is shown in FIG. 9 within the list of the hand gesture history tracking window 930. A “Concept” hands gesture command 907D is associated with event 906D. The concept hands gesture command 907D is configured to direct the system to automatically flag a portion of video lecture content, such as a streaming video or a snippet of a recording, as corresponding to a particular concept. Further, in response to receiving the concept hands gesture command 907D, the system can automatically cause the system to extract the identified concept and to start to record a snippet for that portion of the streaming video. As an example, while the student is viewing the streaming video 910 of a lecture on the AR connected device, the lecturer may present a concept that the student deems as important within the context of the lecture, such as the classifications of enzymes during a lecture for cellular biology. At that point in the streaming video 910, the student can place their hand within the hands gesture command field 915 and make a hand motion that the system recognizes as the defined hands gesture 908D, which causes the system to automatically start recording a snippet and provides an indication (e.g., flag) that that a concept is associated with that snippet and/or portion of the streaming video 910, for instance starting at a time when the hand gesture is entered. Subsequently, the system can analyze the generated snippet in order to automatically extract the particular concept that corresponds, for instance an “enzymes” concept in reference back to the example. Thus, in some embodiments, the indication of the concept can be provided to the education platform, such as the content processing module (shown in FIG. 1) in order to identify concepts in content and associations between concepts. The concept hands gesture command 907D can record a snippet of the streaming video 910 in the same manner as the snippet hands gesture command 907A, described in detail above. In some embodiments, the concept hands gesture command 907D causes the system to automatically tie at least one concept, such as a concept entered by a user or a concept identified by the system, to the recorded snippet.

FIG. 9 shows yet another example of a specific hand gesture, namely captured hand gesture 908D, that can be defined by the system to correspond to a user customizable hands gesture command. Particularly, the captured hand gesture 908D is captured and recognized by the system to trigger the automatic execution of the concept hands gesture command 907D. As seen in FIG. 9, the captured hand gesture 908D is illustrated as a hand with the index finger and the fifth finger (e.g., pinky finger) extending outward (to the left), the thumb extending outward, and the remaining fingers folded against the inside of the palm. Thus, when a hand gesture, corresponding to the shown captured hand gesture 908D, is captured by the system within of the hands gesture commands field 915, the system interprets it as a trigger to automatically execute the capture hands gesture command 907D.

As previously described, the system can include a content processing module (shown in FIG. 1) that automates the processing of generating the plethora of concepts that may be important to educational content and learning activity, for example using a learned model. Accordingly, the system can determine whether any of these auto-generated concepts are included in video lecture content, by parsing and/or analyzing the streaming video or snippet for the concepts, keywords, and key phrases that are known to be associated with the concept (for purposes of identifying the corresponding concept) based on the context. Thus, in an embodiment, the concept hands gesture command 908D can be used by the system to reinforce this analysis used to identify the concepts that are tied to a particular portion of video lecture content. For example, if the system receives the Concept hands gestures command 908B from multiple users at approximately similar times during the streaming video of the lecture 910 (e.g., indicating the same portion/section of the lecture), this can increase the indicator of relative strength of association for each of the concepts that are also identified by the system as corresponding to snippet(s) of that portion of the lecture. In other words, the Concept hands gesture command 908D can serve as a user-generated determination that one or more concepts are presented at a particular time of the video lecture content, which can initiate and/or supplement auto-analysis performed by the system to determine the concepts that are included in the corresponding portion of the streaming video or the corresponding snippet(s).

FIG. 9 also illustrates another event 906E (“Event #E”) that is listed within the hand gesture history tracking window 930. In the example, the event 906E corresponds to a “ToDo” hands gesture command 907D that enables a defined hand gesture to be entered by a user. The ToDo hands gesture command is configured to cause the AR connected device to automatically start recording of a snippet, and automatically adds to a “ToDo” list for the user as the captured action 909E. In some embodiments, adding to a “ToDo” list includes generating user action content that corresponds with the recorded snippet, where the user action content specifies any action that is “to do” which may be desired or required of the user. A user action content that may be added as a “ToDo” action of the user's list can include open the textbook to a certain location, creating an appointment, a reminder (e.g., to turn in homework, open a particular page of book, read certain secondary sources, answer a particular quiz, and so on), etc. In some embodiments, the user action content (“ToDo” action) can be presented as an AR overlay on the generated snippet (or another snippet of the lecture to which the “ToDo” action may correspond).

As an example, at a point during the lecture, the lecturer may mention notable information, such as a date for a test, an assigned reading from specific chapters of a text book, an assignment with an upcoming due date, and the like. The user can simply do a hand motion to execute the ToDo hands gesture command 907E, while watching the streaming video 910, in order to automatically add user action content, also referred to as a “ToDo” action, to a file including other actions for the user. The file can be a “ToDo” list, such as a text file, that includes one or more “to do” actions, user action content, user-generated content, or tasks that are required to be completed the user at a later time. The “ToDo” list can correspond to a specific user, but may also be accessible and/or viewed by other users that have appropriate permissions to the content corresponding to at least one action on the “to do” list, for example the recorded snippet. In some embodiments, the “ToDo” list can be a voice file or a text file. Thus, the executing the ToDo hands gesture command 907D can involve automatically launching a voice recognition/recording application (e.g., voice memo), a hand writing application (e.g., stylus compatible app), or a word processing and/or text entry application on the AR connected device in order to appropriately modify the file to add a “ToDo” action.

FIG. 9 shows an example of the captured hand gesture 908E that automatically executes the To Do hands gesture command 907E. As illustrated in the example, the hand gesture can include the tip of the thumb and the tip of the index finger touching (forming a small circle), and the remaining fingers slightly extending outward (to the right) which is commonly known as the “OK” hands gesture. Thus, when a hand gesture, corresponding to the shown captured hand gesture 908D, is captured by the system within of the hands gesture commands field 915, the system interprets it as a trigger to automatically adds to the “To Do” list corresponding to the user, and starts recording a snippet of the video lecture content. The ToDo hands gesture command 907E can record a snippet of the streaming video 910 in the same manner as the snippet hands gesture command 907A, described in detail above.

Also shown in FIG. 9, is another event 906F (“Event #F”) that is listed within the hand gesture history tracking window 930. The event 906F corresponds to a “Question” hands gesture command 907F, in the example. The question hands gesture command 907F is configured to cause the AR connected device to automatically start recording a snippet, and to automatically capture a user's question as the captured action 909F. For example, a student may be viewing the streaming video 910 of a live lecture, when the lecturer begins to discuss a concept that the student may not fully grasp. Thus, the student may have one or more questions regarding that concept. However, the student may not want to interrupt the flow of the lecture for the other students, by stopping the lecturer from speaking in order to ask their question at that time. In this scenario, instead of raising their hand to ask a question during the lecture, the student can make a simple hand gesture in order to launch the question hands gesture command 907F which automatically captures their question to be presented to the lecturer at a later time. Furthermore, the question hands gesture command 907F can ensure that the system links the user's captured question to the recorded snippet, thereby allowing the user to be able to view the corresponding snippet at a later time to provide some context to the question with respect to the video lecture content.

In some embodiments, the captured question can be a voice file or a text file. Therefore, executing the hands gesture command 907F can involve automatically launching a voice recognition/recording application (e.g., voice memo), a hand writing application (e.g., stylus compatible app), or a word processing and/or text entry application on the AR connected device in order to appropriately capture a question. The user may review the file capturing their question at any point, for example a few hours after the streaming video 910 of the live lecture has ended. Subsequently, the user can perform a related action, such as creating an email, sending the voice file, posting to a message board, or communicating in-person (e.g., office hours) as a means to pose the captured question. The user can employ various communication mechanisms as deemed suitable or appropriate in order to convey the captured question to another person, such as a lecturer, a tutor, or others in the class. In some embodiments, the hands gesture command 907F can automatically launch at least one communication mechanism to provide the capture question for an intended recipient. For example, after a user saves text document including their question, an automated email to the lecturer can be generated having the text document with the question as an attachment. According to some embodiments, the question hands gesture command 907F can record a snippet of the streaming video 910 in the same manner as the snippet hands gesture command 907A, described in detail above.

FIG. 9 shows an example of the captured hand gesture 908F that automatically executes the question hands gesture command 907F. The capture hand gesture 908F is illustrated as a left hand making the “thumbs-up” gesture. Accordingly, when the user makes this hand gesture 908F inside of the hands gesture commands field 915, the system can capture the movement and interpret it as the known captured hands gesture 908F to execute the questions hands gesture command 907F.

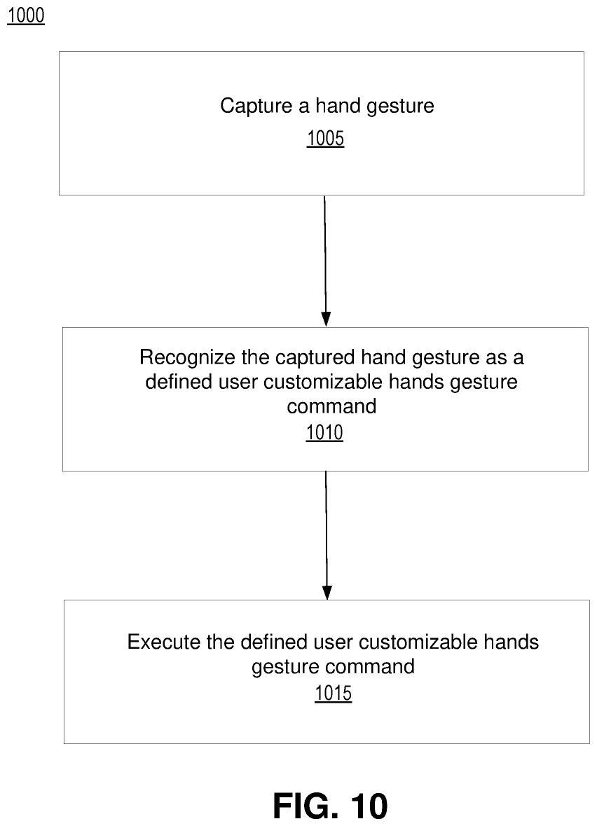

FIG. 10 is a flowchart illustrating a method 1000 of processing a user customizable hands gesture command. Method 1000 is performed either in whole, or in part, by one or more computer processors coupled to a client device. For example, the education platform (shown in FIG. 1) may perform one or more of the steps of the method 1000, or the client device accessing the education platform may perform one or more of the steps of the method 1000. Steps in the method 1000 that are not order-dependent may be reordered and steps may be combined or broken out.

At 1005, a hand gesture is captured. For example, a user can make a specific hand gesture in order to be captured by the system, and ultimately execute a hands gesture command. According to the embodiments, 1005 involves capturing a hand gesture that is made within the hands gestures command field, which is a particular area within a field in front of the client device, for instance the AR connected device display, that enables a user's hand(s) to be captured and accurately recognized by an image capturing device. As an example, a user can move their left hand, right hand, or both hands within the hands gesture command field, such that the image capturing device can detect a hand gesture that is made. In some implementation, the hand gesture is captured by an image capturing device of the user's client device, such as an embedded camera within a laptop computer, an embedded digital camera of a smartphone. Alternatively, the hand gesture can be captured by an external camera that is not integrated within the client device, such as a tracking camera that is tethered to a virtual reality (VR) headset. The captured hand gesture can be captured by the image capturing device as a digital image or video, and communicated to the system as image data that can be subject to further digital image processing techniques, such as image recognition, computerized biometrics, and the like.

At 1010, the captured hand gesture is analyzed in order to recognize if the hand gesture that was previously captured at 1005 corresponds to a defined hands gesture command. Recognition can be performed at 1010 using a number of various image processing techniques. For instance, the digital image or a video frame can be analyzed in order to extract the captured hand gesture within the image data. The extracted hand gesture can be compared against a database of defined hands gesture that are known by the system, such as the library of user customizable hand gestures commands (shown in FIG. 9). Upon determining that the captured hand gesture matches a defined hands gesture command, the system can recognize that the user has entered a hand gesture that corresponds to a particular hands gesture command that has been previously defined by the user and maintained by the system. For example, the system can analyze the captured “thumbs up” hands gesture that was entered by the user, and subsequently determine that this motion particularly corresponds to the defined hand gesture for executing the question hands gesture command. As previously alluded to above, the defined hands gesture commands can include, but are not limited to: a snippet hands gesture command; a MyNotes hands gesture command; a scan hands gesture command; a concept hands gesture command; a ToDo hands gesture command; and a question hand gesture command.

At 1015, the system can execute the defined user customizable hands gesture command. Accordingly, after the captured hand gesture command entered by the user is successfully recognized by the system, the defined user customizable hands gesture command can be automatically executed such that the user can interact with the video lecture content and supplement content in a fast and efficient manner. As previously described, a plurality of user customizable hands gesture commands can be defined, where each user customizable hands gesture command correlates the system's recognition of a hand gesture to the automatic execution of action(s). Actions that are performed in response to executing the defined user customizable hands gesture command generally involve creating additional supplemental content for the video lecture content, such as creating a video snippet, creating a note, or capturing a question. Accordingly, in some implementations, executing the user customizable hands gesture command also includes automatically triggering the associated client device to open associated applications and execute functions in order to complete the action. Furthermore, executing the user customizable hands gesture command can include automatically storing any content that has been automatically generated from performing the command's actions. Referring back to the example of recognizing that the hand gesture corresponds to the question hands gesture commands, executing the command can involve initiating a recording of a snippet of the streamed lecture and automatically launching a voice recognition/recording application (e.g., voice memo), a hand writing application (e.g., stylus compatible app), or a word processing and/or text entry application on the client device in order to appropriately capture a question. Thus, the method 1000 enables various user interactions simply by moving their hand(s), which automatically executes the user customizable hands gesture command. Although additional user input may be received in order to generate the additional supplemental content, for instance the user entering text to capture their question, it should be appreciated that the embodiments allow the method 1000 to initially execute, or launch, the defined user customizable hands gesture commands without any further interactions being required by the user other than the simple hand gesture captured at 1005.

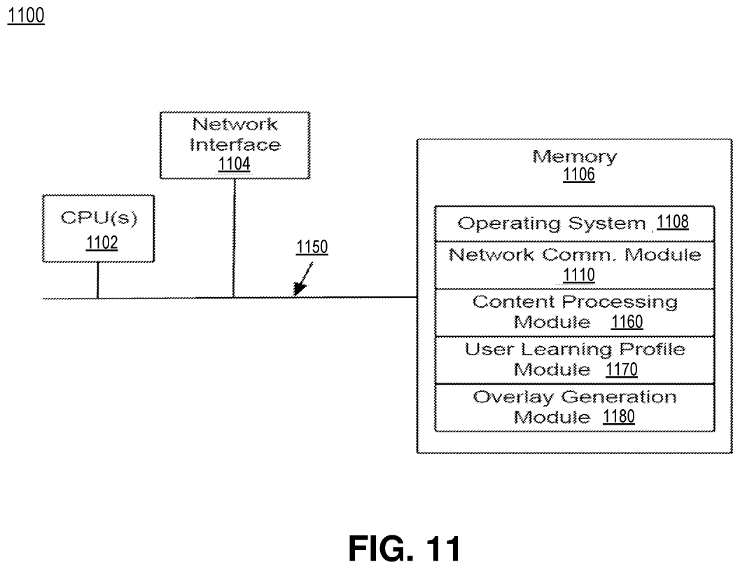

FIG. 11 is a block diagram of a server system 1100 in accordance with some embodiments. The system 1100 may be an example of the education engine (shown in FIG. 1). The system 1100 typically includes one or more processors 1102 (e.g., CPUs and/or GPUs), one or more network interfaces 1104 (wired and/or wireless), memory 1106, and one or more communication buses 1105 interconnecting these components.

Memory 1106 includes volatile and/or non-volatile memory. Memory 1106 (e.g., the non-volatile memory within memory 1106) includes a non-transitory computer-readable storage medium. Memory 1106 optionally includes one or more storage devices remotely located from the processors 1102 and/or a non-transitory computer-readable storage medium that is removably inserted into the server system 1100. In some embodiments, memory 1106 (e.g., the non-transitory computer-readable storage medium of memory 1106) stores the following modules and data:
an operating system 1108 that includes procedures for handling various basic system services and for performing hardware-dependent tasks;
a network communication module 1110 that is used for connecting the education engine 115 to other computing devices via one or more network interfaces 1104 connected to one or more networks 140 (FIG. 1);
content processing module 160 or a portion thereof;
user learning profile module 170 or a portion thereof; and
overlay generation module 180 or a portion thereof.

Each of the modules stored in memory 1106 corresponds to a set of instructions for performing one or more functions described herein. Separate modules need not be implemented as separate software programs. The modules and various subsets of the modules may be combined or otherwise re-arranged. In some embodiments, memory 906 stores a subset or superset of the modules and/or data structures identified above.

FIG. 11 is intended more as a functional description of the various features that may be present in a server system than as a structural schematic. In practice, items shown separately could be combined and some items could be separated. For example, some items shown separately in FIG. 11 could be implemented on a single server and single items could be implemented by one or more servers. The actual number of servers used to implement the system 1100, and how features are allocated among them, will vary from one implementation to another.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configure for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1102 executing one or more sequences of one or more instructions contained in main memory 1106. Such instructions may be read into main memory 1106 from another storage medium, such as a storage device. Execution of the sequences of instructions contained in main memory 1106 causes processor(s) 1102 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus. Transmission media can also take the form of acoustic or light waves, such as those generated during radio-wave and infra-red data communications.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
an augment reality (AR) connected device displaying video lecture content and supplemental content displayed as an AR overlay in relation to the video lecture content;
an image capturing device coupled to the AR connected device, the image capturing device capturing a digital image including a hand gesture; and
one or more computer processors coupled to the AR connected device and the image capturing device, wherein the one or more computer processors execute instructions that cause the one or more processors to:
recognize the captured hand gesture as corresponding to at least one of a plurality of defined user customizable hands gesture commands, and
automatically execute the corresponding defined user customizable hands gesture command on the AR connected device to interact with at least one of the video lecture content and the supplemental content.

2. The system of claim 2, wherein the image capturing device captured the digital image including the hand gesture within a defined area of a field in front of the AR device.

3. The system of claim 1, comprising:
a gesture database storing the plurality of defined user customizable hands gesture commands, wherein each of the plurality of defined user customizable hands gesture commands defines a correlation between a defined hands gesture and one or more actions to be performed on the AR connected device in response to executing the respective defined user customizable hands gesture command.

4. The system of claim 3, wherein the one or more processors further execute instructions that cause the one or more processors to:
analyze the digital image to extract the captured hand gesture within the image data;
compare the captured hand gesture to the defined hands gestures within the gesture database; and
in response to determining that the captured hand gesture matches at least one defined hands gestures, recognize the captured hand gesture as corresponding to the defined user customizable hands gesture command correlated to the matching defined hands gesture.

5. The system of claim 4, wherein each of the defined hands gestures comprises a specified orientation of a right hand, a left hand, or both hands of a user.

6. The system of claim 5, wherein the one or more processors further execute instructions that cause the one or more processors to:
determine that the captured hand gesture matches at least one defined hands gestures by determining that the captured hand gesture includes at least one a specified orientation of a right hand, a left hand, or both hands of the user.

7. The system of claim 1, wherein automatically executing the corresponding defined user customizable hands gesture command on the AR connected device to interact with at least one of the video lecture content and the supplemental content includes recording a snippet of the video lecture content displayed by the AR connected device.

8. The system of claim 1, wherein automatically executing the corresponding defined user customizable hands gesture command on the AR connected device to interact with at least one of the video lecture content and the supplemental content includes capturing a user-generated note.

9. The system of claim 8, wherein automatically executing the corresponding defined user customizable hands gesture command on the AR connected device to interact with at least one of the video lecture content and the supplemental content includes automatically launching an application for creating the user-generated note on the AR connected device based on a type of user-generated note to be captured.

10. The system of claim 9, wherein the application comprises at least one of: a voice recognition application, a stylus writing application, and a word processing application.

11. The system of claim 8, wherein automatically executing the corresponding defined user customizable hands gesture command to interact with the with at least one of the video lecture content and the supplemental content includes recording a snippet of the video lecture content displayed by the AR connected device to generate a snippet that is associated with a time period when the user-generated note is captured.

12. The system of claim 3, wherein automatically executing the corresponding defined user customizable hands gesture command on the AR connected device to interact with at least one of the video lecture content and the supplemental content includes scanning at least one of text and pictures within the video lecture content displayed by the AR connected device.

13. The system of claim 12, wherein scanning at least one of text and pictures within the video lecture content includes scanning a region within a current frame of the video lecture content being displayed on the AR connected device.

14. The system of claim 12, wherein the one or more computer processors automatically execute the corresponding defined user customizable hands gesture command to perform the series of actions comprising recording a snippet of the video lecture content displayed by the AR connected device.

15. The system of claim 3, wherein automatically executing the corresponding defined user customizable hands gesture command on the AR connected device to interact with at least one of the video lecture content and the supplemental content includes extracting a concept from the video lecture content displayed by the AR connected device.

16. The system of claim 15, wherein extracting the concept includes generating an indication that that the concept is associated with a portion of the video lecture content.

17. The system of claim 16, wherein extracting the concept further includes recording a snippet of the portion of the video lecture content associated with the generated indication.

18. The system of claim 3, wherein automatically executing the corresponding defined user customizable hands gesture command on the AR connected device to interact with at least one of the video lecture content and the supplemental content includes capturing at least one indication of a user action associated with the video lecture content.

19. The system of claim 18, wherein the at least one indication of the user action comprises at least one of: viewing the associated video lecture content, creating comments associated with the video lecture content, creating a reminder, creating an appointment, and creating a reminder related to material of the video lecture content.

20. The system of claim 19, wherein the one or more computer processors automatically execute the corresponding defined user customizable hands gesture command to perform the series of actions comprising recording a snippet of the video lecture content associated with the at least one indication of the user action.

21. The system of claim 3, wherein automatically executing the corresponding defined user customizable hands gesture command on the AR connected device to interact with at least one of the video lecture content and the supplemental content includes capturing a user-generated question.

22. The system of claim 21, wherein capturing the user-generated question includes automatically launching an application for creating the user-generated question on the AR connected device based on the type of user-generated question to be captured.

23. The system of claim 22, wherein the launched application comprises at least one of: a voice recognition application, a stylus writing application, and a word processing application.

24. The system of claim 23, wherein capturing the user-generated question includes recording a snippet of the video lecture content associated with the user-generated question.
